(19) United States
(12) Patent Application Publication
(10) Pub. No.: US 2026/0269241 A1
(43) Pub. Date: Sep. 10, 2026

(54) ELECTRODE, BATTERY, AND BATTERY PACK

(71) Applicant: KABUSHIKI KAISHA TOSHIBA, Kawasaki-shi (JP)

(72) Inventors: Takasumi SAITO, Yokohama Kanagawa (JP); Naoki NISHIO, Yokohama Kanagawa (JP); Masanori NAGASAKA, Yokohama Kanagawa (JP)

(73) Assignee: KABUSHIKI KAISHA TOSHIBA, Kawasaki-shi (JP)

(21) Appl. No.: 19/663,379

(22) Filed: Apr. 30, 2026

Related U.S. Application Data
(63) Continuation of application No. PCT/JP2024/033729, filed on Sep. 20, 2024.

(51) Int. Cl. H01M 4/525; H01M 4/02; H01M 4/131; H01M 4/62

(52) U.S. Cl. CPC H01M 4/525; H01M 4/131; H01M 4/625; H01M 2004/021; H01M 2004/028

(57) ABSTRACT

One embodiment provides an electrode including an active material-containing layer containing an active material and 1st and 2nd electro-conductive agents. An integral intensity ratio I_{D}/I_{G} of D band to G band is 0.5<I_{D}/I_{G}<2 and 0<I_{D}/I_{G}<0.5, respectively for the 1st and 2nd electro-conductive agents. In a constituent material mapping image for the active material-containing layer, occupancy areas S1, S2, and Sa of the 1st and 2nd electro-conductive agents and the active material satisfy 0.1<S1/Sa<1.0 and 0.8<S2/Sa<10, and inter-centroid distances R1, R2, Ra, and R1-2 for the 1st and 2nd electro-conductive agents, active material, and between the 1st and 2nd electro-conductive agents satisfy 1.0<R1/Ra<1.5, 0.5<R2/Ra<1.0, and R1>R2>R1-2.

### CROSS-REFERENCE TO RELATED APPLICATION

This application is a Continuation Application of PCT Application No. PCT/JP2024/033729, filed Sep. 20, 2024, the entire contents of which are incorporated herein by reference.

### FIELD

Embodiments of the present invention relate to an electrode, battery, and battery pack.

### BACKGROUND

Secondary batteries, including nonaqueous electrolyte secondary batteries such as lithium ion secondary batteries, have been implemented not only in electronic devices such as mobile phones but also in vehicles such as hybrid automobiles and electric automobiles, and widely spread. In these applications, large capacity performance, long life performance, improvement in output performance, and the like are demanded on the batteries.

As a negative electrode active material of a nonaqueous electrolyte battery, graphite is generally used. Graphite forms LiC₆ by Li insertion, and has a theoretical capacity of 372 mAh/g. In addition, since graphite reacts at a potential of about 0.1 V (vs. Li/Li⁺) relative to a Li reaction potential (the potential at which insertion-extraction reaction of Li occurs), a battery having a high output and a high energy density can be obtained by using a graphite negative electrode. On the other hand, since the Li insertion reaction potential of graphite is close to a Li precipitation potential, lithium dendrite readily precipitates due to overvoltage or the like. Since an internal short circuit occurs when the dendrite penetrates a separator, a battery using a graphite negative electrode is defective in that safety is low. In addition, in graphite, expansion and contraction occurs along a c-axis direction in accordance with Li insertion-extraction, and therefore graphite undergoes large structural deterioration. When a compound that reacts at a high potential of 0.5 V (vs. Li/Li⁺) or more relative to the Li reaction potential, for example, spinel lithium titanate (Li₄Ti₅O₁₂) is used as another negative electrode active material of the nonaqueous electrolyte battery, precipitation of lithium dendrite can be suppressed. It is known that as a result, risks such as short circuit, self-discharge, and ignition can be avoided, and a battery having excellent life performance can be produced.

Examples of a positive electrode active material of the nonaqueous electrolyte battery include lithium nickel-cobalt-manganate excellent in large capacity performance. A conventional battery using lithium nickel-cobalt-manganate in a positive electrode and lithium titanate in a negative electrode is characterized in that it is excellent in rapid charge-discharge performance, long-term life performance, and low-temperature performance as compared with a battery using a graphite-based negative electrode. On the other hand, there is room for improvement regarding the positive electrode active material. In particular, there is a problem in life performance. During charge-discharge cycles, in lithium nickel-cobalt-manganate particles of the positive electrode, particle cracking of the active material, an irreversible change to a deteriorated structure such as a rock salt type structure, and the like occur. This causes a decrease in capacity, an increase in electric resistance, and the like every time a cycle is undergone. Conventional lithium nickel-cobalt-manganate is generally a polycrystalline system in which primary particles having fine particle shapes are agglomerated to form secondary particles. In the case of a positive electrode using such an active material, there is a problem that an oxidation reaction between the positive electrode and an electrolyte is apt to occur, particularly in charge and discharge using a high potential, resulting in remarkable gas generation and resistance increase.

Oppositely, by using in the positive electrode an active material with a small surface area such as a single crystalline one, side reactions between the active material and the electrolyte can be alleviated. On the contrary, however, there is a concern in that contact between the active material and the electro-conductive agent decreases as the surface area becomes smaller, separating the electrode interior into portions where electrical current flows easily and portions where electrical current does not flow easily, whereby local deterioration of the active material may occur.

In addition, carbon or the like is added as an electro-conductive agent to a conventional lithium secondary battery electrode obtained using a lithium-containing metal oxide as an active material in order to retain an electrically conductive path between active materials in the electrode. If the electro-conductive agent is not appropriately dispersed between the active materials in the electrode, the electro-conductive agent is aggregated to form an electrically conductive path only by itself, and a current more readily flows through the aggregate of the electro-conductive agent rather than the active material. This may cause problems such as unevenness in current distribution, reduction of the pressability at the time of production of the electrode due to the electro-conductive agent as an aggregate, and weakening of the binding force between the layer containing the active material and the current collector.

### BRIEF DESCRIPTION OF THE DRAWINGS

FIG. 1 is a plan view schematically illustrating an example of an electrode according to an embodiment.

FIG. 2 is a cross-sectional view schematically illustrating the example of the electrode according to the embodiment.

FIG. 3 is a conceptual diagram illustrating a constituent material mapping image by Raman spectroscopy for an active material-containing layer of the example of the electrode according to the embodiment.

FIG. 4 is a conceptual diagram illustrating a constituent material mapping image by Raman spectroscopy for an active material-containing layer of an example of a conventional electrode.

FIG. 5 is a conceptual diagram illustrating a method of calculating a distance between centroids in a constituent material mapping image by Raman spectroscopy.

FIG. 6 is a conceptual diagram illustrating a method of calculating a distance between centroids in a constituent material mapping image by Raman spectroscopy.

FIG. 7 is a conceptual diagram illustrating a method of calculating a distance between centroids in a constituent material mapping image by Raman spectroscopy.

FIG. 8 is a conceptual diagram illustrating a method of calculating a distance between centroids in a constituent material mapping image by Raman spectroscopy.

FIG. 9 is a graph illustrating a distribution of distances between centroids of an active material-containing layer of an example of a conventional electrode.

FIG. 10 is a graph illustrating a distribution of distances between centroids of the active material-containing layer of the example of the electrode according to the embodiment.

FIG. 11 is a cross-sectional view of a battery of an example of according to the embodiment taken along a thickness direction.

FIG. 12 is an enlarged cross-sectional view of a portion A in FIG. 11.

FIG. 13 is a partially cutaway perspective view of another example of a battery according to the embodiment.

FIG. 14 is an exploded perspective view of an example of a battery pack according to the embodiment.

FIG. 15 is a block diagram illustrating an electric circuit of the battery pack illustrated in FIG. 14.

### DETAILED DESCRIPTION

According to one embodiment, provided is an electrode including an active material-containing layer containing an active material, a first electro-conductive agent, and a second electro-conductive agent. In a Raman chart according to Raman spectroscopy on the active material-containing layer, a ratio I_{D}/I_{G} of an integral intensity I_{D} of a D band appearing at 1350±10 cm⁻¹ to an integral intensity I_{G} of a G band appearing at 1590±10 cm⁻¹ for the first electro-conductive agent falls within a range of 0.5<I_{D}/I_{G}<2. In the Raman chart, a ratio I_{D}/I_{G} for the second electro-conductive agent falls within a range of 0<I_{D}/I_{G}<0.5. In a constituent material mapping image according to Raman spectroscopy on the active material-containing layer, a ratio S1/Sa of an occupancy area S1 of the first electro-conductive agent to an occupancy area Sa of the active material falls within a range of 0.1<S1/Sa<1.0. In the constituent material mapping image, a ratio S2/Sa of an occupancy area S2 of the second electro-conductive agent to the occupancy area Sa of the active material falls within a range of 0.8<S2/Sa<10. In the constituent material mapping image, a ratio R1/Ra of an inter-centroid distance R1 for the first electro-conductive agent to an inter-centroid distance Ra for the active material falls within a range of 1.0<R1/Ra<1.5. In the constituent material mapping image, a ratio R2/Ra of an inter-centroid distance R2 for the second electro-conductive agent to the inter-centroid distance Ra for the active material falls within a range of 0.5<R2/Ra<1.0. In the constituent material mapping image, the inter-centroid distance R1 for the first electro-conductive agent, the inter-centroid distance R2 for the second electro-conductive agent, and an inter-centroid distance R1-2 between the first electro-conductive agent and the second electro-conductive agent satisfy a relationship of R1>R2>R1-2.

According to another embodiment, provided is a battery including the above electrode and an electrolyte.

According to yet another embodiment, provided is a battery pack including the above battery.

One of conventional life performance improvement means is an increase in the amount of electro-conductive agent. If the amount of the electro-conductive agent is too small, there is difficulty in maintaining electrical contact among electrode members including an active material, and resistance of the electrode increases. On the other hand, if the amount of the electro-conductive agent is excessively increased, aggregation of the electro-conductive agent is likely to occur. As a result, the current easily flows only in a region with a low resistance, so that the active material becomes locally deteriorated, leading to deterioration of life performance.

In a conventional positive electrode for lithium secondary battery obtained using a lithium-containing metal composite compound as a positive electrode active material, in order to enhance the life performance of the positive electrode, there may be used an active material having a small specific surface area with which a side reaction hardly occurs. However, in the case of using an active material having a small specific surface area, not only is electrical contact between the positive electrode active material and the electro-conductive agent difficult to obtain, but also the electrical contact is likely to be lost due to expansion and contraction of the positive electrode accompanying charge and discharge of the battery. In such a positive electrode, a current preferentially flows in a portion where contact between the active material and the electro-conductive agent is favorably maintained, whereby the positive electrode potential may become locally increased. Therefore, there is a tendency that an increase in resistance, remarkable gas generation, and the like occur due to deterioration of the positive electrode active material at the portion where the positive electrode potential becomes high.

Therefore, in order to suppress the deterioration of the active material, the particle shape is controlled and coating is applied. However, regardless of the shape and the surface state, if the specific surface area of the positive electrode is large, the side reaction increases whereby the electrical resistance rises, and if the specific surface area is small, there is a concern that local deterioration as described above may occur. Therefore, these measures do not fundamentally solve the deterioration of the active material.

Hereinafter, embodiments will be described with reference to the drawings. The same reference signs are applied to common components throughout the embodiments and overlapping explanations are omitted.

Each drawing is a schematic view for explaining the embodiment and promoting understanding thereof; though there may be differences in shape, size and ratio from those in an actual device, such specifics can be appropriately changed in design taking the following explanations and known technology into consideration.

### First Embodiment

According to the first embodiment, an electrode is provided. The electrode includes an active material-containing layer containing an active material, a first electro-conductive agent, and a second electro-conductive agent. In a Raman chart obtained by measuring the active material-containing layer according to Raman spectroscopy, both the first electro-conductive agent and the second lector-conductive agent have a D band appearing at 1350±10 cm⁻¹ and a G band appearing at 1590±10 cm⁻¹. A ratio I_{D}/I_{G} of an integral intensity I_{D} of the D band to an integral intensity I_{G} of the G band for the first electro-conductive agent in the above Raman chart falls within a range of 0.5<I_{D}/I_{G}<2. A ratio I_{D}/I_{G} for the second electro-conductive agent in the above Raman chart falls within a range of 0<I_{D}/I_{G}<0.5. In a constituent material mapping image according to Raman spectroscopy for the active material-containing layer, a ratio S1/Sa of an occupancy area S1 of the first electro-conductive agent to an occupancy area Sa of the active material falls within a range of 0.1<S1/Sa<1.0. In the constituent material mapping image, a ratio S2/Sa of an occupancy area S2 of the second electro-conductive agent to the occupancy area Sa of the active material falls within a range of 0.8<S2/Sa<10. In the constituent material mapping image, a ratio R1/Ra of an inter-centroid distance R1 for the first electro-conductive agent to an inter-centroid distance Ra for the active material falls within a range of 1.0<R1/Ra<1.5. In the constituent material mapping image, a ratio R2/Ra of an inter-centroid distance R2 for the second electro-conductive agent to the inter-centroid distance Ra for the active material falls within a range of 0.5<R2/Ra<1.0. In the constituent material mapping image, the inter-centroid distance R1 for the first electro-conductive agent, the inter-centroid distance R2 for the second electro-conductive agent, and an inter-centroid distance R1-2 between the first electro-conductive agent and the second electro-conductive agent satisfy a relationship of R1>R2>R1-2.

The electrode according to the embodiment may be a battery electrode. An example of the battery within which the electrode may be included is a secondary battery such as a lithium ion secondary battery. The secondary battery includes nonaqueous electrolyte secondary batteries containing nonaqueous electrolyte(s). The electrode may be a positive electrode for a battery, for example.

The electrode satisfying the above configuration is an electrode using a plurality of electro-conductive agents differing in physical properties, together with the active material. Specifically, the electrode is an electrode in which the electro-conductive agents are uniformly dispersed through the shapes and addition amounts of the electro-conductive agents and control of the dispersion method. Even if the electrode includes an active material having a large capacity but suffering large deterioration due to a structural change at a high potential or an active material with little side reaction but disadvantageous for electrical contact due to simultaneously having a large particle size and a small specific surface area, drawbacks of these active materials can be canceled, and the life performance of the battery can be greatly improved.

For example, carbon black such as acetylene black widely used as an electro-conductive agent exhibits electrical conductivity based on the percolation theory. Therefore, carbon black desirably has a small particle size, a large specific surface area, and a developed agglomerate structure. However, in an electrode using an active material having a small specific surface area, in order to form and maintain an electrical conductive network between the active materials, the amount of carbon black required for electrical contact increases. In this case, aggregation of the carbon black easily proceeds, and the form of the carbon black is changed from an agglomerate structure suitable for exhibiting electrical conductivity to an aggregate structure. When aggregates are present, regions having a smaller resistance than that of the active material become large, and electrical current preferentially flows in those regions. Accordingly, the charge-discharge reaction of the active material near aggregates is promoted, so that the positive electrode potential increases, leading to local deterioration of the active material, and as a result, the life performance is lowered.

Therefore, a highly crystalline material having a large particle size and high orientation, such as flake graphite, which is considered to contribute little to electrical conductivity, is added and appropriately made present between the carbon black and the active material. This can improve the formation and retention of the electrical conductive network.

Carbon black has a large integral intensity of the D band due to the disturbance of the structure, and the ratio of I_{D} to I_{G} satisfies a relationship of 0.5<I_{D}/I_{G}<2.0. Namely, examples of the first electro-conductive agent described above include carbon black. In addition, since the highly crystalline carbon has a large integral intensity of the G band due to a stacked structure, the ratio of I_{D} to I_{G} satisfies a relationship of 0<I_{D}/I_{G}<0.5. Such highly crystalline carbon is an example of a second electro-conductive agent, and includes the above-described flake graphite. As such, they can be distinguished by Raman spectroscopy. In addition, a metal oxide such as a lithium-nickel-cobalt-manganese composite oxide does not have a D band or a G band. This makes it possible to obtain a constituent material mapping image by binarizing each of these three phases in the Raman chart of the active material-containing layer and then superimposing them.

In addition, the occupancy area of each phase on the constituent material mapping image changes according to the blending ratio of the first electro-conductive agent and the second electro-conductive agent differing in physical properties. Therefore, whether the electro-conductive agents are contained at an appropriate blending ratio can be ascertained from the proportions of the occupancy areas of the active material, the first electro-conductive agent, and the second electro-conductive agent obtained by image analysis of the constituent material mapping image. Taking the occupancy areas of the active material, the first electro-conductive agent, and the second electro-conductive agent as Sa, S1, and S2, respectively, relationships of 0.1<S1/Sa<1.0 and 0.8<S2/Sa<10 are satisfied in the electrode according to the embodiment, whereby the formation of aggregates of the first electro-conductive agent (such as carbon black) is suppressed, and the dispersion of the second electro-conductive agent (such as highly crystalline carbon) is improved. Therefore, the resistance of the electrode can be reduced, and the life performance of the battery can be improved. In addition, since the dispersion of the electro-conductive agents in the active material-containing layer is controlled, the first electro-conductive agent maintains the above-described favorable agglomerate structure of carbon black, and an electrical conductive network of the entire electrode is formed by the second electro-conductive agent (such as highly crystalline carbon). Therefore, the electrode can improve life performance of the battery by suppressing deterioration due to charge-discharge cycles. Specifically, the three phases are dispersedly arranged within the active material-containing layer in positional relationships in which inter-centroid distances Ra, R1, and R2 respectively for the active materials, the first electro-conductive agent, and the second electro-conductive agent in the constituent material mapping image, and an inter-centroid distance R1-2 between the first electro-conductive agent and the second electro-conductive agent respectively satisfy relationships of 1.0<R1/Ra<1.5 and 0.5<R2/Ra<1.0, and R1>R2>R1-2, and thus the electrode can provide the above effect.

In the electrode, the ratio of the occupancy areas obtained from the constituent material mapping image obtained by measuring the cross-section of the active material-containing layer by Raman spectroscopy satisfies the relationships of 0.1<S1/Sa<1.0 and 0.8<S2/Sa<10, respectively, so that the electrical resistance is reduced and the current unevenness is suppressed. The occupancy areas of the electro-conductive agents in the cross section of the active material-containing layer reflect the ratios of presence of the electro-conductive agents contributing to electrical conductivity. Namely, the ratio of the occupancy area of the electro-conductive agent to the occupancy area of the active material is an index representing electrical contact within the electrode. When 0.1>S1/Sa or S1/Sa>1.0, too little or too much of the first electro-conductive agent such as carbon black may be present. In that case, sufficient electrical conductivity cannot be obtained, or the occurrence of current unevenness due to the formation of aggregates may become remarkable. When 0.8>S2/Sa or S2/Sa>10, too little or too much of the second electro-conductive agent (highly crystalline carbon) may be present. If the amount of the highly crystalline carbon is excessively small, an intended electrical conductive network cannot be formed, so that the above-described effect does not appear. On the other hand, if the highly crystalline carbon is present in excessive amount, the first electro-conductive agent cannot sufficiently play the role of electrically connecting the individual particles, leading to local deterioration of the active material. More preferably, relationships of S1/Sa<0.8 and 2.0<S2/Sa<4.0 are desirably satisfied, respectively. In an electrode having a preferable occupancy area ratio, in which the first electro-conductive agent is reliably present between the active materials, and the second electro-conductive agent is present crossing thereacross, the effect of improving the life performance is more remarkably obtained.

Since the active materials, the first electro-conductive agent, and the second electro-conductive agent are dispersed in the mutual positional relationship in which the above-described distances between centroids determined from the constituent material mapping image obtained from the measurement of the cross section of the active material-containing layer by Raman spectroscopy satisfy the relationships of 1.0<R1/Ra<1.5 and 0.5<R2/Ra<1.0, and R1>R2>R1-2, an electrode having excellent life performance can be obtained. Through simple consideration of only the occupancy areas, performance may not be improved in a case where dispersion is poor and imbalanced. When 1.0>R1/Ra or R1/Ra>1.5, the first electro-conductive agent having high electrical conductivity may be present insufficiently or in excess around the active material. If the amount is too little, the charge-discharge reaction does not sufficiently occur, and if the amount is too much, the electrical current more readily flows as compared with other active materials, leading to local deterioration. When 0.5>R2/Ra or R2/Ra>1.0, the second electro-conductive agent may be present insufficiently or in excess around the active material. If the amount is too little, the formation of an electrical conductive network in the electrode may be insufficient, and if the amount is too much, the first electro-conductive agent necessary for electrical conduction between particles is insufficient, and the charge-discharge reaction may not sufficiently occur. When R1<R2 or R1-2<R2, the highly electrically conductive first electro-conductive agent may be present in excess. In that case, electrical current more readily flows through nearby active materials than other active materials, leading to local deterioration. When R2<R1-2 or R1<R1-2, the first electro-conductive agent and the second electro-conductive agent may be present in independent regions. In that case, mutual or complementary effects between the electro-conductive agents cannot be obtained, and the effect of improving life performance may not be obtained.

The active material-containing layer may contain, as an active material, a lithium-nickel-cobalt-manganese composite oxide represented by the formula LiₐNi_{(1-b-c-d)}Co_{b}Mn_{c}M_{d}O₂. The subscripts in the formula are within ranges of 1≤a≤1.2, 0≤b≤0.4, 0≤c≤0.4, and 0≤d≤0.1, respectively. M includes at least one selected from the group consisting of Fe, Cu, Ti, Mg, Al, W, Y, B, Mo, Nb, Zn, Sn, Zr, Ga, and V.

The active material may have an average primary particle diameter of 2 μm or more and 7 μm or less. The life performance of the battery can be improved by having the primary particle diameter of the active material particles be 2 μm or more and 7 μm or less in the active material-containing layer. With the primary particle diameter being 2 μm or more, the specific surface area of the electrode is little, and influences of side reactions between the electrode and the electrolyte on the life performance can be made little. In addition, with the primary particle diameter being 7 μm or less, in-solid diffusion of lithium ions within the particles is uniform, suppressing local structural deterioration and thereby improving life performance. More preferably, the primary particle diameter is desirably 3 μm or more and 4.5 μm or less. Aggregation and isolation of the primary particles is more readily prevented in the more preferable range, and thus, the above-described inter-centroid distances can be satisfied more easily.

The specific surface area of the active material determined according to a nitrogen adsorption/desorption method is preferably within a range of 0.5 m²/g or more and 1.0 m²/g or less. When the specific surface area is 0.5 m²/g or more, permeation of the electrolyte solution into the active material-containing layer is promoted, and the output performance and the life performance are improved. When the specific surface area is 1.0 m²/g or less, the contact between the active material and the electro-conductive agent is increased, whereby the electric resistance is further reduced, and the large current output performance is improved. In addition, the mechanical stability of the electrode is increased.

The electrode can further include a current collector. The current collector may have, for example, a foil shape, a band shape, or a plate shape. The active material-containing layer may be provided on a surface of at least one principal surface of the current collector. Namely, the current collector can support the active material-containing layer on one surface or both of obverse and reverse surfaces. The current collector may include a portion that does not support the active material-containing layer on the surfaces thereof. This portion can serve as a current-collecting tab. Alternatively, the electrode may include a current-collecting tab separate from the current collector.

The active material-containing layer may contain a binder, in addition to the active material and the electro-conductive agents. The binder may be blended to bind the dispersed active materials and electro-conductive agents, and to bind the active materials and electro-conductive agents with the current collector.

### Materials

Next, materials that may be used for the active material-containing layer included in the electrode according to the first embodiment and for the current collector that may be included in the electrode will be described.

### <Active Material-Containing Layer>

A density of the active material-containing layer is preferably 2.0 g/cm³ or more and less than 4.0 g/cm³. In an electrode having a density in the above range, the contact between the active material and the electro-conductive agent is improved, whereby a more favorable electrical conductive network can be formed, and thus the electric resistance is made uniform within the active material-containing layer. Therefore, with such an electrode, a battery having excellent life performance can be produced. When the density is 2.0 g/cm³ or more, the contact between the active material, first electro-conductive agent, and second electro-conductive agent are improved, whereby the electric resistance in the active material-containing layer is made even, making the life performance of the battery favorable. In addition, mechanical stability of the electrode is improved. When the density is less than 4.0 g/cm³, permeation of the electrolyte solution into the active material-containing layer is promoted, and the life performance is improved. More preferably, the density is desirably 3.20 g/cm³ or more and less than 3.50 g/cm³. In the more preferable range, the resistance uniformization effect is greater, whereby local deterioration of the active material is reduced, making a further long life battery capable of being obtained.

As mentioned above, the active material-containing layer may contain a binder, in addition to the active material and electro-conductive agents. The blending proportions of the active material, electro-conductive agents and binder in the active material-containing layer are preferably within the ranges of 63% by mass to 99% by mass of the active material, 0.5% by mass to 36% by mass of the electro-conductive agents, and 0.5% by mass to 17% by mass of the binder. The above blending proportion of electro-conductive agents is a sum blending proportion between the first electro-conducive agent and second electro-conductive agent. The respective contents of the first electro-conducive agent and second electro-conductive agent within the active material-containing layer are preferably of the same degree. Specifically, the mass ratio of each of the first electro-conducive agent and the second electro-conductive agent relative to the mass of the active material-containing layer may respectively be 0.0025 or more and 0.18 or less.

### <Active Material>

The active material-containing layer may contain the lithium-nickel-cobalt-manganese composite oxide (for example, LiₐNi_{(1-b-c-d)}Co_{b}Mn_{c}M_{d}O₂, where 1≤a≤1.2, 0≤b≤0.4, 0≤c≤0.4, and 0≤d≤0.1; M includes at least one selected from the group consisting of Fe, Cu, Ti, Mg, Al, W, Y, B, Mo, Nb, Zn, Sn, Zr, Ga, and V) as the active material, as mentioned above. Other compounds may be used as the active material, but preferably the above lithium-nickel-cobalt-manganese composite oxide is at least included as an active material. Even more preferable is inclusion of an active material that includes the lithium-nickel-cobalt-manganese composite oxide and that has an average primary particle diameter within a range of 2 μm or more and 7 μm or less. For example, the active material-containing layer may contain the lithium-nickel-cobalt-manganese composite oxide as the first active material and, further, a second active material other than this. As a matter of course, the first active material may be used alone, and alternatively, one or more second active material may be included without including any of the first active material.

As the second active material, various oxides, for example, lithium-cobalt composite oxides (for example, LiCoO₂), manganese dioxide, lithium-manganese composite oxides (for example, LiMn₂O₄ and LiMnO₂), lithium-nickel composite oxides (for example, LiNiO₂), lithium-nickel-cobalt composite oxides (for example, LiNi_{0.8}Co_{0.2}O₂), lithium-containing iron oxides, vanadium oxides containing lithium, chalcogen compounds such as titanium disulfide and molybdenum disulfide, and the like may be included. The electrode may contain one of the above compounds as the second active material, or include two or more of the above compounds as the second active material.

A proportion of a mass of the first active material among an entire mass of active materials contained in the active material-containing layer is preferably 75 mass % or more and 100 mass % or less, and more preferably 80 mass % or more and 100 mass % or less.

The active material can have, for example, a particle shape. Namely, the active material-containing layer can contain particles of the active material. The active material particles may be primary particles or a mixture of primary particles and secondary particles.

Preferably among the active material particles, a proportion of the primary particles is large and a proportion of the secondary particles is small. The electrical conductivity inside the secondary particles (inside a hollow structure) is poor, and so, by eliminating the presence of the primary particles contained therein, the contact between the active material particles and the electro-conductive agent is improved, making further reduction of the electric resistance possible.

From the above, the aggregation of secondary particles of the active material is desirably resolved, whereas the primary particles of the active material are desirably not further pulverized, so as to maintain a particle size of 2 μm or more. By refraining from pulverizing the primary particles of the active material, an active material having a good crystal structure is obtained, and good life performance can be maintained. By having the average particle diameter of the active material be 2 μm or more, the specific surface area of the electrode can be reduced, and the influence of side reactions between the electrode and the electrolyte on the life performance can be reduced. On the other hand, by having the average particle diameter be 7 μm or less, in-solid diffusion of lithium ions within the particles can be made uniform, whereby life performance can be further improved.

### <Electro-Conductive Agents>

The electro-conductive agents include at least the first electro-conductive agent that is a carbon material in which the ratio I_{D}/I_{G} of an integral intensity I_{D} of a D band appearing at 1350±10 cm⁻¹ to an integral intensity I_{G} of a G band appearing at 1590±10 cm⁻¹ in a Raman chart by Raman spectroscopy is within a range of 0.5<I_{D}/I_{G}<2, and a second electro-conductive agent that is a carbon material in which the ratio I_{D}/I_{G} is within a range of 0<I_{D}/I_{G}<0.5. Roughly, the first electro-conductive agent is a carbon material having a low graphitization degree, and the second electro-conductive agent is a carbon material having high crystallinity and a high graphitization degree.

Specific examples of the first electro-conductive agent include carbon black such as acetylene black, Ketjen black, and furnace black. Specific examples of the second electro-conductive agent include graphite, graphene, single-walled carbon nanotubes, and double-walled carbon nanotubes. Multi-walled carbon nanotubes may have a ratio I_{D}/I_{G} of 0.5 or less or 0.5 or more depending on the manufacturing method. The carbon nanotubes play different roles in the active material-containing layer depending on the length thereof. Short carbon nanotubes can develop electrical conductivity based on percolation theory, like carbon black, and may construct agglomerate structures. Long carbon nanotubes can form an electrical conductive network, like flake graphite. In addition, as the second electro-conductive agent, a material having high orientation such as highly oriented graphite is preferred. For example, graphite includes, in addition to flake graphite having high orientation, spherical graphite having low orientation. Natural graphite is flake graphite. The spherical graphite is graphite obtained by performing spheroidizing treatment. The active material-containing layer contains at least one species of the first electro-conductive agent and at least one species of the second electro-conductive agent. The active material-containing layer may contain an electro-conductive agent in combination of one species of the first electro-conductive agent and two or more species of the second electro-conductive agent, or in combination of two or more species of the first electro-conductive agent and one species of the first electro-conductive agent. In addition, the active material-containing layer may contain two or more species of each of the first electro-conductive agent and the second electro-conductive agent.

The first electro-conductive agent may have a particle shape, for example. From the viewpoint of forming an agglomerate structure, the average particle size (primary particle size) of the first electro-conductive agent is desirably small. For this reason, the average particle size of the first electro-conductive agent is desirably 100 nm or less. For example, it is preferable to add acetylene black having an average particle size in the range of 20 nm or more and 100 nm or less and excellent electrical conductivity as the first electro-conductive agent. A more preferable range of the average particle size of the first electro-conductive agent is 30 nm or more and 70 nm or less.

The second electro-conductive agent may have a flaked shape, for example. The second electro-conductive agent can form an electrical conductive network by having a large particle size, but from the viewpoint of ensuring dispersibility with which a positional relationship with the active material and the first electro-conductive agent described above is easily obtained, the average particle size of the second electro-conductive agent is preferably 10 μm or less. The average particle size of the second electro-conductive agent is more preferably 1 μm or less.

Although details will be described later, the particle size of each of the first electro-conductive agent and the second electro-conductive agent herein refers to an equivalent circle diameter, that is, a diameter in a spherical shape in a case where the electro-conductive agent particles are assumed to have spherical shapes with the same volume or the same cross-sectional area.

The mass ratio of each of the first electro-conductive agent and the second electro-conductive agent relative to the active material is preferably 0.18 or less. Namely, the first electro-conductive agent is preferably contained in an amount of 18 parts by mass or less and the second electro-conductive agent is contained in an amount of 18 parts by mass or less with respect to 100 parts by mass of the active material.

### <Binder>

As the binder, a material containing a fluorine atom within its molecule is preferable for being excellent in oxidation resistance and improving life performance. Examples of such a binder include polytetrafluoroethylene (PTFE), polyvinylidene fluoride (PVdF), and fluororubbers. Other than that, as the binder, for example, styrene butadiene rubber, an acrylic resin and a copolymer thereof, polyacrylic acid, polyacrylonitrile, and the like may be used. The active material-containing layer may contain one species of the above binders, or may contain two or more species of the above binders.

### <Current Collector>

As the current collector, for example, a metal foil or an alloy foil may be used. Examples of the metal foil include an aluminum foil, a stainless steel foil, and a nickel foil. Examples of the alloy foil include an aluminum alloy, a copper alloy, and a nickel alloy.

Next, specific examples of the electrode according to the first embodiment will be described with reference to the drawings.

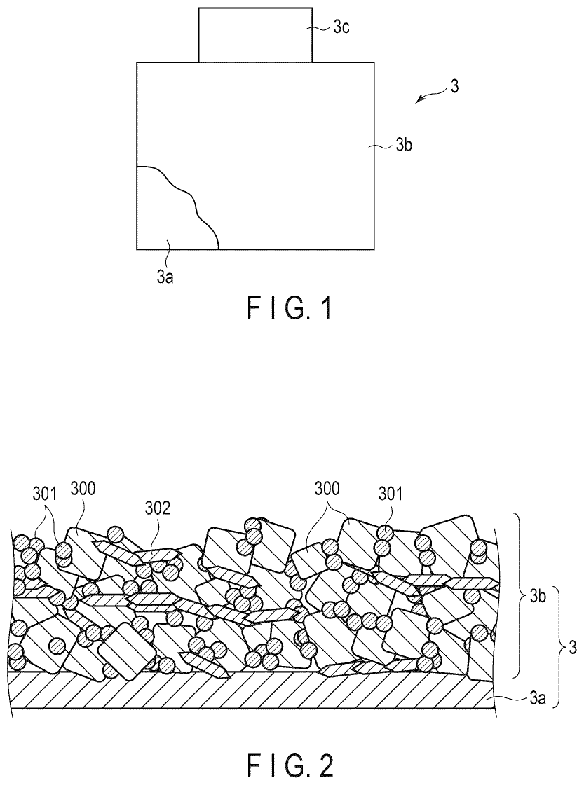

FIG. 1 is a partially cutaway plan view schematically illustrating an example of the electrode according to the embodiment. Here, an example of a positive electrode is illustrated as an example of the electrode. FIG. 2 is a cross-sectional view schematically illustrating an example of the electrode.

The positive electrode 3 illustrated in FIGS. 1 and 2 includes a positive electrode current collector 3a and a positive electrode active material-containing layer 3b provided on a surface of the positive electrode current collector 3a. The positive electrode active material-containing layer 3b is supported on a principal surface of the positive electrode current collector 3a. In the illustrated example, the positive electrode active material-containing layer 3b is provided on one principal surface of the positive electrode current collector 3a, but the positive electrode active material-containing layer 3b may be provided on both obverse and reverse principal surfaces of the positive electrode current collector 3a.

In addition, the positive electrode current collector 3a includes a portion where the positive electrode active material-containing layer 3b is not provided on the surface thereof. This portion serves as a positive electrode current-collecting tab 3c, for example. In the illustrated example, the positive electrode current-collecting tab 3c is a narrow portion having a width narrower than that of the positive electrode active material-containing layer 3b. The width of the positive electrode current-collecting tab 3c may be smaller than the width of the positive electrode active material-containing layer 3b as described above, or may be the same as the width of the positive electrode active material-containing layer 3b. Instead of the positive electrode current-collecting tab 3c which is a portion of the positive electrode current collector 3a, a separate electrically conductive member may be electrically connected to the positive electrode 3 and used as an electrode current-collecting tab (positive electrode current-collecting tab).

The positive electrode active material-containing layer 3b contains at least a positive electrode active material 300, a first electro-conductive agent 301, and a second electro-conductive agent 302. Although an example is not illustrated, the positive electrode active material-containing layer 3b may further contain a binder. The first electro-conductive agent 301 is distributed so as to fill gaps between the particles of the positive electrode active material 300, and forms an electrical conductive path between the particles of the positive electrode active material 300. The first electro-conductive agent 301 having a particle shape is concentrated in some gaps in the positive electrode active materials 300, whereby the first electro-conductive agent 301 forms an agglomerate structure. The second electro-conductive agent 302 having a flake shape is dispersed so as to connect the agglomerate structures of the first electro-conductive agent 301, thereby forming an electrical conductive network within the positive electrode active material-containing layer 3b.

### Production Method

The electrode according to the first embodiment can be produced by the following method, for example.

The active material, the first electro-conductive agent, the second electro-conductive agent, and an optional binder are put into an appropriate solvent to obtain a mixture. However, the first electro-conductive agent and the second electro-conductive agent are respectively stirred in a powder state, added together, stirred again, and then added to the solvent. This can reduce the difference in the progress of dispersion between the first electro-conductive agent and the second electro-conductive agent. In addition, the mixed powder of the first electro-conductive agent and the second electro-conductive agent obtained by stirring is put into the solvent, after the other materials are put in. At this time, any dispersant may be used in order to improve the dispersibility of each electro-conductive agent and the dispersibility between the electro-conductive agents. In addition, the order of putting in the electro-conductive agents may be changed according to the species of the electro-conductive agents used. By controlling the process, the distance between centroids in the cross-section of the post-production electrode can be controlled.

Subsequently, the resulting mixture is put into a stirrer. In the stirrer, the mixture is stirred to obtain a slurry. In addition, in the stirring step, the rotation of the stirrer can be weakened, so as to obtain a slurry that sufficiently sustains the electrical conductive network of the electro-conductive agents. Conversely, the rotation of the stirrer can be strengthened so as to obtain a slurry having a good dispersion state of the active material. By using the slurry obtained by weakening or strengthening the stirring in this manner, the occupancy area and the distance between centroids of each member in the cross section of the produced electrode can be controlled. In addition, by increasing the rotation speed of the stirrer, promotion of grinding of the active material/electro-conductive agent particles is possible, whereby the value of the specific surface area of the electrode after production cab be increased. The stirring mechanism in the stirrer to be used may be changed according to the species of the electro-conductive agents to be used.

The thus obtained slurry is applied onto both obverse and reverse surfaces or one surface of the current collector. At this time, a portion where the slurry is not applied to any surface may be left on the current collector. Next, the coating film is dried and pressed. At this time, the electrode density can be improved by increasing the pressing load, and there is a tendency where an electrode having good electrical contact and excellent capacitance is more easily produced when the electrode density is made higher. The increase in the pressing load can change not only the electrode density but also the distance between centroids of each member in the cross-section of the electrode after production. For example, when the pressing load is large, the active material may become pulverized or crushed depending on the shape and strength of the active material, so that an occupancy area Sa of the active material in the cross section increases or an inter-centroid distance Ra decreases. In addition, since the highly oriented and highly crystalline carbon material has a large spread in the planar direction, the cross-sectional area of the material as observed from the cross-section can be changed by changing the pressing load. Therefore, for the highly crystalline second electro-conductive agent having high orientation, an occupancy area S2 in the cross-section tends to decrease when the pressing load is large.

In this manner, an electrode can be produced.

The occupancy area and the distance between centroids in the mapping image for the active material-containing layer can be adjusted to fall within the ranges described above, for example, by adjusting parameters such as the selection and blending ratios of the species of the active material, the electro-conductive agents, and the binder, the particle sizes of particles of the active material and the electro-conductive agents, the stirring (dispersion) condition of the mixture, and the pressing condition. For example, for each of the active material, the first electro-conductive agent, and the second electro-conductive agent, the occupancy areas Sa, S1, and S2 tend to be higher when the compound ratio is increased or the particle size is increased. For each member, the inter-centroid distances Ra, R1, and R2 tend to be shorter when the blending ratio is increased or the particle size is increased. However, the electrode according to the first embodiment cannot be produced without being aware of the perception of adjusting the dispersion state or the like of each member of the active material-containing layer so as to satisfy the above-described relationships 0.1<S1/Sa<1.0 and 0.8<S2/Sa<10 of the ratio of the occupancy areas and the above-described relationships 1.0<R1/Ra<1.5, 0.5<R2/Ra<1.0, and R1>R2>R1-2 of the distances between centroids in the constituent material mapping image obtained by Raman spectroscopy for the active material-containing layer containing the first and second electro-conductive agents together with the active material.

For example, in the mixing step, the dispersion state changes due to a difference in solubility parameter between the dispersion solvent and the binder due to a change in the order of putting the active material and the first and second electro-conductive agents into the solvent. In addition, as described above, the stirring strength in the stirring step affects the values of the inter-centroid distances and the occupancy areas of the active material and the electro-conductive agents in the obtained electrode. Moreover, regarding the pressing load, in an electrode having an extremely high or low density produced by excessive pressing or insufficient pressing, not only does the electrode density deviate from the above-described preferable range, but also the ratio of the occupancy areas and the ratio of the inter-centroid distances tend to deviate from the above-described ranges. Accordingly, the above-described relationship cannot be unintentionally satisfied.

Specific examples of electrode production will be described later in Examples.

A preferred active material containing the above-described lithium-nickel-cobalt-manganese composite oxide and having an average primary particle size of 2 μm or more and 7 μm or less can be obtained as described below, for example. Precursors using nickel, cobalt, and manganese sources are fired. Here, when the firing temperature is increased, the firing time is increased, or the charged amount of a precursor as lithium source such as lithium carbonate is increased, particle growth is promoted rather than nucleation. Therefore, by promoting particle growth through a method of choice, a lithium-nickel-cobalt-manganese composite oxide with a primary particle size of 2 μm or more and an optimized chemical composition having a nickel content ratio of a predetermined value or more can be synthesized.

### Measurement of Electrode

Various measurement methods for the electrode will be described. Specifically, a method of measuring the composition of the active material, a method of measuring the particle size distribution in the active material-containing layer and the average particle diameter of the active material particles by a laser diffraction scattering method, a method of measuring the specific surface area of the active material by the nitrogen adsorption/desorption method, a method of measuring the density of the active material-containing layer, a method of obtaining the Raman chart according to Raman spectroscopy, methods of image analysis of the Raman chart, and a method of measuring an average particle size of the electro-conductive agents by electron microscope observation. Described as methods of image analysis of the Raman chart are, a method of obtaining the constituent material mapping by image analysis and a method of measuring the occupancy areas and inter-centroid distances.

When analyzing an electrode incorporated in a battery, the electrode is taken out by the following procedures.

First, a battery to be measured is prepared. The battery to be measured should have a discharge capacity of 80% or more of the nominal capacity. That is, an excessively deteriorated battery should not be measured.

Next, the prepared battery is discharged until the open-circuit voltage becomes 2.0 V to 2.2 V. The discharged battery is then transferred into an argon-filled glove box in which the dew point of the internal atmosphere is −70° C. The battery is cut-open in such a glove box. An electrode group is taken out from the cut-open battery. When the taken-out electrode group includes a positive electrode lead and a negative electrode lead, the positive electrode lead and the negative electrode lead are cut taking precaution so as to avoid short-circuiting between the positive electrode and the negative electrode.

Next, the electrode group is dismantled and disassembled into a positive electrode, a negative electrode, and a separator. For example, the positive electrode is selected as the electrode to be measured. The electrode thus obtained is washed with ethyl methyl carbonate as a solvent. In this washing, the member obtained by disassembly is completely immersed in the ethyl methyl carbonate solvent, and left in that state for 60 minutes.

After washing, the electrode is subjected to vacuum drying. The vacuum drying is carried out by reducing the pressure from atmospheric pressure to −97 kpa or more in a 25° C. environment and retaining that state for 10 minutes. The electrode thus taken out through the disassembly, washing and vacuum drying is subjected to the following measurements.

### <Measurement of Active Material Composition>

The composition of the electrode active material can be known by measuring a surface of the electrode by X-ray fluorescence (XRF).

### <Measurement of Particle Size Distribution by Laser Diffraction Scattering Method>

The particle size distribution with respect to the electrode can be measured by a laser diffraction scattering method described as follows.

After preparing the electrode to be measured, the active material-containing layer is taken off from the electrode using, for example, a spatula to obtain a powdery electrode mixture specimen including the active material. Next, the powdery sample is charged into a measurement cell filled with N-methylpyrrolidone (NMP) up to the concentration at which measurement becomes possible. The capacity of the measurement cell and the measurable concentration vary depending on the particle size distribution measuring device.

The measurement cell containing NMP and the electrode mixture specimen dissolved therein is irradiated with ultrasonic waves at an output of 40 W for 5 minutes. Such ultrasonic irradiation can resolve the agglomeration between the electro-conductive agent particles and the active material particles.

The measurement cell that has been subjected to the ultrasonic treatment is inserted into a particle size distribution measuring device using a laser diffraction scattering method, and the particle size distribution is measured. An example of the particle size distribution measuring device is Microtrac 3100.

In this manner, the particle size distribution of the active material-containing layer can be obtained.

The particle diameter distribution of the active material particles can be obtained by performing the above measurement using a specimen of the active material particles. The average primary particle diameter of the active material can be determined from the particle diameter distribution of the active material particles.

The electrode mixture specimen is dispersed and stirred in NMP, and then solid content obtained by filtering off the solvent is fired to remove the binder and the electro-conductive agent, thereby isolating the active material particles. The particle diameter (D₅₀), at which the cumulative frequency from the small particle diameter side is 50% in the particle diameter distribution measured using the obtained specimen of the active material particles, corresponds to the average primary particle diameter of the active material.

### <Measurement of Specific Surface Area of Active Material by Nitrogen Adsorption/Desorption Method>

The specific surface area by the nitrogen (N₂) adsorption/desorption method for the active material corresponds to the BET specific surface area of active material particles. The BET specific surface area is a specific surface area determined by the BET method, and is calculated by the N₂ gas adsorption/desorption method. Analysis is performed, for example, by the following method.

By separating the active material-containing layer from the current collector as described above, a powdery electrode mixture specimen including the active material is obtained from the electrode. The obtained powdery specimen is heated in air for a short time (about 1 hour at 500° C.) to burn away unneeded portions such as binder components and carbon. The weight of the remaining active material sample is measured. Next, the measurement sample is filled into a cell of a measuring device. The sample put into the measurement cell for nitrogen adsorption/desorption measurement is dried at a temperature of 120° C. or higher under a N₂ gas flow. Thereafter, the specific surface area is measured by a BET one-point method or a BET multi-point method. An example of the measuring device that performs N₂ gas adsorption/desorption measurement is Quantasorb manufactured by QUANTACHROME.

### <Measurement of Density of Active Material-Containing Layer>

The density of the active material-containing layer can be measured by the following procedures.

First, the thickness of the prepared electrode is measured using a thickness measuring apparatus. Then, the electrode is punched out in a size of 1 cm×1 cm using a cutting apparatus to obtain a specimen having a size of 1 cm×1 cm. The weight of this specimen is measured.

Next, the active material-containing layer is removed from the specimen. For example, the active material-containing layer can be removed by immersing the specimen in N-methylpyrrolidone. Any solvent may be used as the solvent for removing the active material-containing layer, as long as the current collector is not eroded and the active material-containing layer can be removed. The thickness and weight of the current collector specimen remaining as the specimen are measured.

Next, the thickness of the current collector is subtracted from the thickness of the electrode to calculate the thickness of the active material-containing layer. Further, the weight of the current collector specimen is subtracted from the weight of the specimen having a size of 1 cm×1 cm to calculate the weight of the active material-containing layer having a size of 1 cm×1 cm. Then, the density (unit: g/cm³) of the active material-containing layer can be calculated by dividing the weight of the active material-containing layer having a size of 1 cm×1 cm by the thickness of the active material-containing layer.

### <Measurement by Raman Spectroscopy>

Next, a procedure for obtaining a constituent material mapping image for the active material-containing layer using Raman spectroscopy will be described.

### (Acquisition of Raman Chart)

The electrode taken out by the above-described method is sampled. The sampling is performed at 10 nondiscriminatory points of the electrode to be measured. At this time, a sampling method by which samples are obtained from 10 different points in the electrode is more preferable than a sampling method by which a sample obtained from one specific point in the electrode is divided into 10 points. In addition, sampling is more preferably performed in an electrode portion having a thickness such that the entire measurement visual field becomes an electrode cross-sectional image, particularly, a cross-sectional image of the active material-containing layer in Raman spectrometry described later.

Each electrode sample obtained by sampling by the above-described method is fixed in a state in which the cross-section of the active material-containing layer faces a direction from which a laser for Raman measurement is emitted. As a specific example of the fixing method, a sample can be prepared as follows. The sample is placed in a container such that the sample cross-section faces straight upward, and the sample is fixed to the bottom surface of the container with a metal fitting. The electrode sample can be fixed in a state where the electrode cross-section faces toward any chosen direction by pouring a curable resin into the container and leaving the container standing still until curing of the resin is completed. Thereafter, a new cross-section can be exposed by mechanically cutting along a plane parallel to the bottom surface, whereby a measurement sample can be produced in such a manner that makes the cross-section observable. At this time, graphitization may progress depending on the carbon material used, and thus the energy at the time of cutting needs to be lowered to such an extent that the measurement is not affected.

The sample is fixed to a sample stage and loaded into a Raman spectrometer. The loaded sample is subjected to surface Raman spectrometry in a field of view of 50 μm×50 μm to obtain a Raman chart. When obtaining the Raman chart, measurement is performed at 10,000 points obtained by dividing the 50 μm×50 μm field of view by 100 points in a longitudinal direction and 100 points in a lateral direction. Examples of the measurement device that performs Raman spectrometry include a confocal microspectroscopic analyzer α300 manufactured by WITec GmbH and the like. The measurement conditions are as follows, for example. However, if the thermal influence on the sample is large, shortening of the exposure time and increasing of the number of accumulations, or lowering of the laser power is necessary. On the contrary, in cases where the acquired spectrum is unclear, lengthening of the exposure time or increasing of the number of accumulations is necessary:
Exposure time: 10 s or 20 s
Number of accumulations: 1
Lens magnification: 50 times
Measurement range: 50 μm×50 μm
Laser power: 5%

### (Creation of Constituent Material Mapping Image)

Next, using the Raman chart for the 10,000 points, spectra are extracted from 10 nondiscriminatory points in each high concentration region to obtain an average spectrum. Multivariate analysis is performed on this average spectrum to separate significant spectral components. For each of the separated component spectra, the crystallinity of the active material, the first electro-conductive agent, and the second electro-conductive agent is determined from the peak position, the intensity, and the intensity ratio. The proportion of presence of each constituent material is mapped using the obtained spectrum for each of the constituent materials and the Raman chart for the 10,000 points. Although the first electro-conductive agent and the second electro-conductive agent have a D band and a G band at close positions in the Raman chart, the presence of the first electro-conductive agent and the presence of the second electro-conductive agent at that point can be distinguished from each other by calculating the degree of overlap by fitting using solitary spectra respectively for each. The proportion of presence of each constituent material can be expressed by shades of different colors for each constituent material, for example.

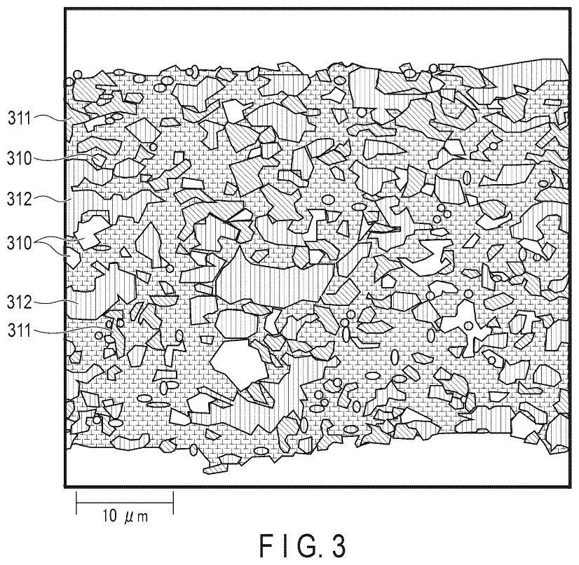

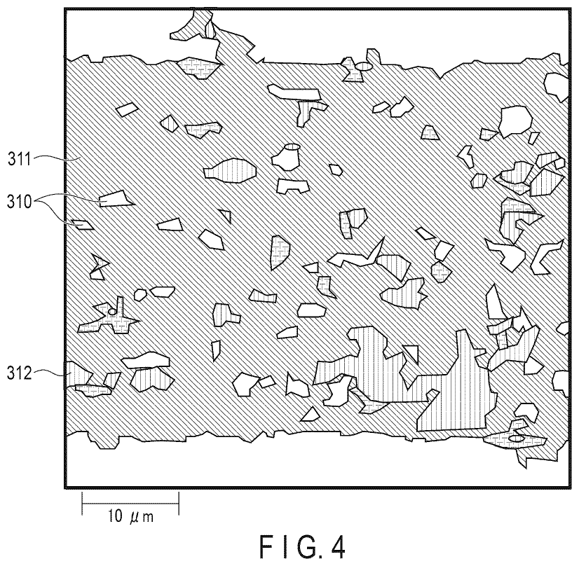

FIGS. 3 and 4 illustrate examples of the constituent material mapping image created from the Raman chart by conceptual diagrams. FIG. 3 illustrates a mapping image for an active material-containing layer of an example of the electrode according to the embodiment, and FIG. 4 illustrates a mapping image for an active material-containing layer of an example of a conventional electrode. Each drawing corresponds to a schematic diagram of a constituent material mapping image in which an active material 310 is indicated by white regions, a first electro-conductive agent 311 is indicated by green regions, a second electro-conductive agent 312 is indicated by red regions, and the rest is indicated by yellow regions. Note, that horizontally long blank bands seen above and below each drawing correspond to upper and lower spaces in the thickness direction outside the cross section of the active material-containing layer.

In the mapping image of the example of the electrode according to the embodiment illustrated in FIG. 3, the active material 310, the first electro-conductive agent 311, and the second electro-conductive agent 312 are evenly distributed within the field of view. In particular, the second electro-conductive agent 312 is present spanning the entire area and at the same time is adjacent to the active material 310, thereby forming an electrical conductive network. In addition, the first electro-conductive agent 311 is also present throughout, so that the conductivity of the entire area within the active material-containing layer is improved. Therefore, in the sample of the example illustrated in FIG. 3, charging and discharging are uniformly performed in the electrode.

In contrast, in the mapping image according to the example of the conventional electrode illustrated in FIG. 4, the first electro-conductive agent 311 occupies most of the field of view and the second electro-conductive agent 312 has a locally concentrated distribution, although part of the second electro-conductive agent 312 is adjacent to the active material 310, and there is not formed an electrical conductive network. The uneven distribution of the electro-conductive agent causes unevenness in the distribution of the charge-discharge reaction, so that local deterioration will progress in the electrode.

### (Measurement of Occupancy Area and Inter-centroid Distance)

In the mapping image, the occupancy areas Sa, S1, and S2 of the active material, the first electro-conductive agent, and the second electro-conductive agent, the ratios S1/Sa and S2/Sa thereof, and the inter-centroid distances Ra, R1, and R2 of the active material, the first electro-conductive agent, and the second electro-conductive agent, and the ratios R1/Ra and R2/Ra thereof can be obtained by numerical analysis of data of mapping of the constituent materials obtained as described above. The inter-centroid distance R1-2 of the first electro-conductive agent and the second electro-conductive agent cannot be directly measured from the mapping data, but can be obtained by calculation using the distances between centroids of all the electro-conductive agents including the first electro-conductive agent and the second electro-conductive agent, the inter-centroid distance R1 amongst the first electro-conductive agent, and the inter-centroid distance R2 amongst the second electro-conductive agent. Note that the inter-centroid distances Ra, R1, R2, and R1-2 obtained by the measurement indicate the arithmetic average values of the distances between centroids in the mapping image.

At this time, the constituent material mapping image to be used for image analysis is selected such that the occupancy area for all of the active material, the first electro-conductive agent, and the second electro-conductive agent is at least 1 μm² or more. If the occupancy area of at least one or more constituent materials out of the active material, the first electro-conductive agent, and the second electro-conductive agent is 1 μm² or less, the constituent material mapping image is not suitable for measuring the occupancy area and the inter-centroid distances. More preferably, the occupancy area of the positive electrode active material is 10 μm² or more.

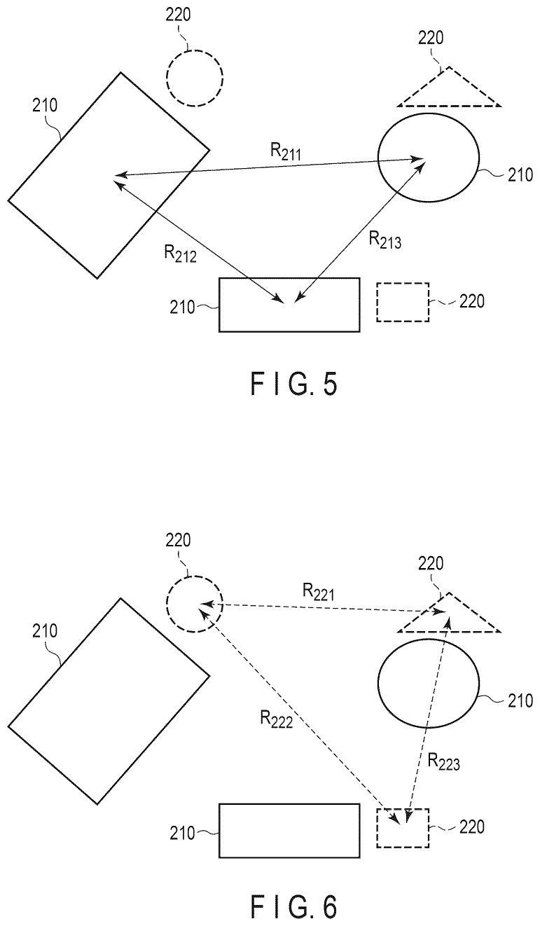

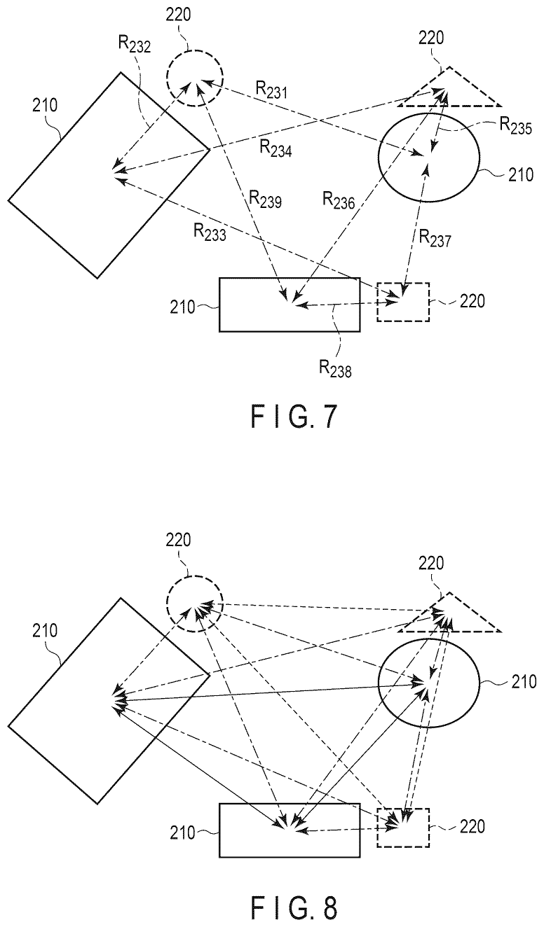

A method of obtaining the inter-centroid distance R1-2 between the first electro-conductive agent and the second electro-conductive agent will be described with reference to the drawings. FIGS. 5 to 8 conceptually illustrate a method of obtaining the distances between centroids of the first electro-conductive agent and the second electro-conductive agent in the mapping image. In these drawings, only the first electro-conductive agent and the second electro-conductive agent are conceptually illustrated for promoting understanding, and the active material is omitted. By numerical analysis of the mapping data, direct measurement of inter-centroid distances R211, R212, and R213 between first electro-conductive agents 210 as illustrated in FIG. 5 and direct measurement of inter-centroid distances R221, R222, and R223 between second electro-conductive agents 220 as illustrated in FIG. 6 are possible. However, inter-centroid distances R231 to R239 between the first electro-conductive agent 210 and the second electro-conductive agent 220 as illustrated in FIG. 7 cannot be directly measured by numerical analysis of the mapping data. However, if the first electro-conductive agent 210 and the second electro-conductive agent 220 are not distinguished from each other but are considered to belong to the same group, direct measurement of all the inter-centroid distances between the first electro-conductive agents 210, between the second electro-conductive agents 220, and between the first electro-conductive agent 210 and the second electro-conductive agent 220 as illustrated in FIG. 8 is possible. Therefore, the inter-centroid distances R231 to R239 between the first electro-conductive agent 210 and the second electro-conductive agent 220 illustrated in FIG. 7 can be determined by measuring the distances between centroids of all the electro-conductive agents as illustrated in FIG. 8 and subtracting the inter-centroid distances R211, R212, R213, R221, R222, and R223 of only the first electro-conductive agents 210 and only the second electro-conductive agents 220 illustrated in FIGS. 5 and 6, respectively.

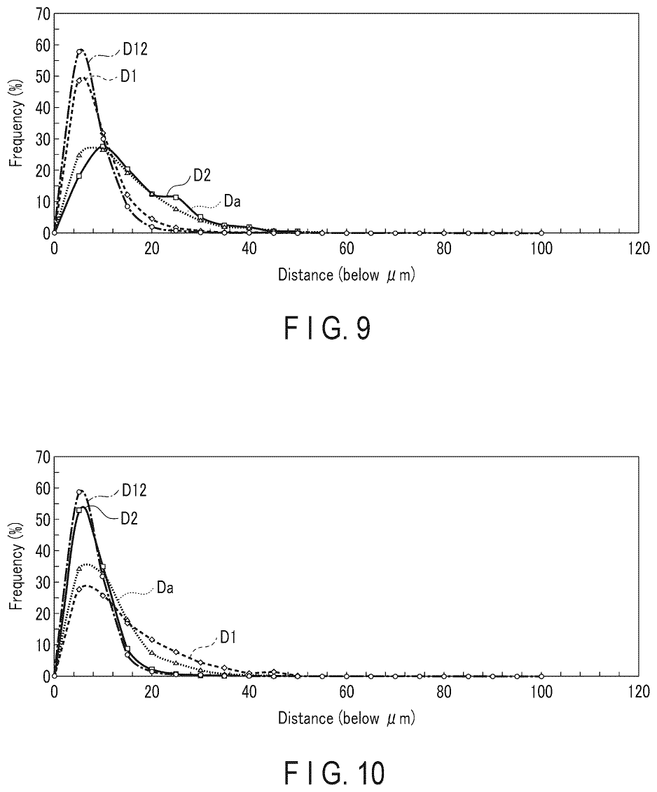

An example of measurement results of the distances between centroids will be described. First, FIGS. 9 and 10 illustrate graphs representing the distances between centroids obtained for the mapping images illustrated in FIGS. 3 and 4, as a distribution indicating the frequency for each distance between centroids. FIG. 9 is a graph of the distance between centroids obtained for the example of the conventional electrode illustrated in FIG. 4. FIG. 10 is a graph of the distance between centroids obtained for the example of the electrode of the embodiment illustrated in FIG. 3. In each graph, a dotted line Da represents the frequency distribution (histogram) of the distance between centroids of the active material, and the integrated area under the curve is equal to the average value Ra of the distance between centroids of the active materials in each mapping image. The integrated area under a dashed line D1 corresponding to the first electro-conductive agent is equal to the average value R1 of the distances between centroids of the first electro-conductive agents in the mapping image. The integrated area under a solid line D2 corresponding to the second electro-conductive agent is equal to the average value R2 of the distances between centroids of the second electro-conductive agents in the mapping image. The integrated area under a dashed-dotted line D12 representing the frequency distribution of the distances between centroids between the first electro-conductive agent and the second electro-conductive agent is equal to the average value R12 of the distances between centroids between the first electro-conductive agent and the second electro-conductive agent in the mapping image.

Table 1 below summarizes data of the distances between centroids corresponding to the distribution illustrated in FIG. 10.

TABLE 1

| | | | | | | | Notation |
|---|---|---|---|---|---|---|---|
| | Respective | Minimum | Maximum | Accumulated | | Average | corresponding |
| | curve in | value | value | value | Median | value | to average |
| | FIG. 10 | [μm] | [μm] | [μm] | [μm] | [μm] | value |
| Inter-centroid | D1 | 0.6 | 53 | 8447.9 | 9.3 | 11.8 | R1 |
| distance between | | | | | | | |
| first | | | | | | | |
| electro-conductive | | | | | | | |
| agents | | | | | | | |
| Inter-centroid | D2 | 0.6 | 45.2 | 18811.0 | 4.8 | 5.9 | R2 |
| distance between | | | | | | | |
| second | | | | | | | |
| electro-conductive | | | | | | | |
| agents | | | | | | | |
| Inter-centroid | Da | 0.7 | 46.5 | 14829.0 | 7.2 | 8.9 | Ra |
| distance between | | | | | | | |
| active materials | | | | | | | |
| Inter-centroid | D12 | 0.6 | 43.9 | 15638.3 | 4.3 | 5.4 | R1-2 |
| distance between | | | | | | | |
| first | | | | | | | |
| electro-conductive | | | | | | | |
| agent and | | | | | | | |
| second | | | | | | | |
| electro-conductive | | | | | | | |
| agent | | | | | | | |

(Verification of Measurement Results and Analysis

### Results)

Through the above-described measurement and analysis, a Raman chart, an average spectrum, multivariate analysis results, a constituent material mapping image, and occupancy areas and distances between centroids of the constituent materials can be obtained for 10 measurement samples. In a case where each numerical value falls within the above-described range and satisfies the above-described relationship for three or more of the 10 measurement samples, the relevant electrode is effective for the above-described improvement of the life performance of the battery. The number of samples is more preferably six or more, in which case, a high effect will be obtained.

In addition, with respect to a measurement sample for which the active material, the first electro-conductive agent, and the second electro-conductive agent cannot be separated in the measurement results or the analysis results, or any of the active material, the first electro-conductive agent, and the second electro-conductive agent is not included in the results, effective measurement/analysis on the sample is determined to not have been performed, and the sample is excluded from the 10 samples.

### <Measurement of Average Particle Size of Electro-Conductive Agent>

The average particle size of each electro-conductive agent can be determined, for example, by observing the cross-section observed in the Raman spectrometry with a transmission electron microscope (TEM). Alternatively, the active material-containing layer may be removed from the taken-out electrode and dispersed in a solvent such as ethanol to perform sampling and TEM observation. In addition, since the observed shape and the value of interplanar spacing d₀₀₂ of the graphene plane ((002) plane) are different depending on the electro-conductive agent, different species of electro-conductive agents can be distinguished from each other by electron microscope observation. For example, as the graphite-likeness is higher, the interplanar spacing d₀₀₂ has a value closer to 0.335 nm. The correspondence to the first electro-conductive agent and the second electro-conductive agent in the TEM image can be examined by comparing the constituent material mapping image obtained by Raman spectrometry with the TEM image.

As the particle size of 30 particles randomly selected from each of various electro-conductive agents, for example, equivalent circle diameters are calculated by image analysis using image analysis software “Particle Analysis” ver. 3.5 manufactured by Nippon Steel Technology Co., Ltd. and the average value of the obtained equivalent circle diameters is taken as the average particle size. The average particle size is typically a diameter of a spherical shape in a case where the particles are assumed to have the spherical shape with the same volume or the same cross-sectional area. However, in the image analysis, take precaution so as to not calculate the equivalent circle diameters of clumps such as aggregates and agglomerates.

The electrode according to the first embodiment includes an active material-containing layer that contains at least an active material, a first electro-conductive agent, and a second electro-conductive agent. The first electro-conducive agent is a material for which a ratio I_{D}/I_{G} of an integral intensity I_{D} of a D band to an integral intensity I_{G} of a G band determined through Raman spectroscopy is within a range of 0.5<I_{D}/I_{G}<2. The second electro-conductive agent is a material whose ratio I_{D}/I_{G} is within a range of 0<I_{D}/I_{G}<0.5. In a constituent material mapping image according to Raman spectroscopy for the active material-containing layer, an occupancy area Sa and inter-centroid distance Ra of the active material, an occupancy area S1 and inter-centroid distance R1 of the first electro-conductive agent, an occupancy area S2 and inter-centroid distance R2 of the second electro-conductive agent, and inter-centroid distance R1-2 between the first electro-conductive agent and the second electro-conductive agent satisfy relationships of 0.1<S1/Sa<1.0, 0.8<S2/Sa<10, 1.0<R1/Ra<1.5, 0.5<R2/Ra<1.0, and R1>R2>R1-2. The electrode can realize a battery excellent in life performance that has little electrical resistance, with excellent capacity retention ratio and suppressed resistance increase.

### Second Embodiment

According to a second embodiment, a battery is provided. The battery includes the electrode according to the first embodiment and an electrolyte. As described above, the electrode according to the first embodiment can realize a battery having excellent life performance. Therefore, the battery according to the second embodiment can have excellent life performance.

Such a battery may include a positive electrode and a negative electrode. The battery may include the electrode according to the first embodiment as the positive electrode.

The battery may further include a separator provided between the positive electrode and the negative electrode. The positive electrode, the negative electrode, and the separator may configure an electrode group. The electrolyte may be held in the electrode group.

The battery may further include a container member that houses the electrode group and the electrolyte.

The battery may further include a positive electrode terminal electrically connected to the positive electrode and a negative electrode terminal electrically connected to the negative electrode. Each electrode terminal may be connected to, for example, a current-collecting tab of the corresponding electrode. At least a part of the positive electrode terminal and at least a part of the negative electrode terminal may extend outside the container member.

The battery may be, for example, a lithium ion secondary battery. The battery also includes, for example, a nonaqueous electrolyte battery containing a nonaqueous electrolyte as the electrolyte.

Hereinafter, the positive electrode, negative electrode, electrolyte, separator, container member, positive electrode terminal, and negative electrode terminal will be described in detail.

### (1) Positive Electrode

The positive electrode includes a positive electrode current collector and a positive electrode active material-containing layer(s) (positive electrode mixture layer(s)) supported on one surface or both the obverse and reverse surfaces of the positive electrode current collector and containing a positive electrode active material, an electro-conductive agent, and a binder.

The positive electrode may be the electrode according to the first embodiment. In an aspect as the positive electrode, the positive electrode current collector, the positive electrode active material, and the positive electrode active material-containing layer of the positive electrode correspond respectively to the current collector, the active material, and the active material-containing layer of the electrode according to the first embodiment. Since the electrode according to the first embodiment has been described in detail above, the description of the positive electrode here is omitted.

### (2) Negative Electrode

The negative electrode includes a negative electrode current collector and a negative electrode active material-containing layer(s) (negative electrode mixture layer(s)) supported on one surface or both the obverse and reverse surfaces of the negative electrode current collector. The negative electrode active material-containing layer contains a negative electrode active material. The negative electrode active material-containing layer can further contain an electro-conductive agent and a binder, in addition to the negative electrode active material. The electro-conductive agent may be blended to improve current collection performance and to suppress the contact resistance between the negative electrode active material and the negative electrode current collector. The binder may be blended to bind the dispersed negative electrode active materials and to bind the negative electrode active material and the negative electrode current collector.

### Material

Hereinafter, materials that can be used in the negative electrode active material-containing layer and the negative electrode current collector will be described.

### <Negative Electrode Active Material-Containing Layer>

The blending proportions of the negative electrode active material, electro-conductive agent and binder in the negative electrode active material-containing layer are preferably within the ranges of 70% by mass to 96% by mass of the negative electrode active material, 2% by mass to 28% by mass of the electro-conductive agent, and 2% by mass to 28% by mass of the binder. With the amount of the electro-conductive agent being 2% by mass or more, the current collecting performance of the negative electrode active material-containing layer can be improved, and therefore, excellent large current performance and low temperature performance can be expected. With the amount of the binder being 2% by mass or more, binding between the negative electrode active material-containing layer and the current collector will be sufficient, and therefore, excellent cycle performance can be expected.

On the other hand, from the perspective of achieving high capacity, 28% by mass or less of each of the electro-conductive agent and binder are preferable.

### <Negative Electrode Active Material>

The negative electrode preferably contains a negative electrode active material capable of having lithium ions inserted and extracted at a potential of 0.4 V (vs. Li/Li⁺) or more. In the battery according to the second embodiment including such a negative electrode, precipitation of lithium due to charge and discharge can be suppressed. Therefore, such a battery is more excellent in rapid charge-discharge performance.

Examples of the negative electrode active material capable of having lithium ions inserted and extracted at a potential of 0.4 V (vs. Li/Li⁺) or more include lithium titanate having a spinel crystal structure represented by Li₄₊ₓTi₅O₁₂ (x varies within a range of −1≤x≤3 according to charge-discharge reaction), Li₂₊ₓTi₃O₇ having a ramsdellite crystal structure (x varies within a range of −1≤x≤3 according to charge-discharge reaction), and a metal composite oxide containing Ti and at least one selected from the group consisting of P, V, Sn, Cu, Ni, and Fe. Examples of the metal composite oxide containing Ti and at least one selected from the group consisting of P, V, Sn, Cu, Ni, and Fe include TiO₂—P₂O₅, TiO₂—V₂O₅, TiO₂—P₂O₅—SnO₂, and TiO₂—P₂O₅-MeO (Me is at least one element selected from the group consisting of Cu, Ni, and Fe). These metal composite oxides are transformed into lithium titanium composite oxides upon insertion of lithium through charging. Of the lithium titanium composite oxides, a spinel lithium titanate is excellent in cycle performance and preferable.

The negative electrode may contain another active material, and examples thereof include carbonaceous materials and metal compounds.

Examples of the carbonaceous material include natural graphite, artificial graphite, coke, vapor-grown carbon fibers, mesophase pitch-based carbon fibers, spherical carbon, and resin-fired carbon. More preferable examples of the carbonaceous material include vapor-grown carbon fibers, mesophase pitch-based carbon fibers, and spherical carbon. The carbonaceous material preferably has lattice spacing d002 between (002) planes of 0.34 nm or less according to X-ray diffraction.

As the metal compound, a metal sulfide, a metal nitride, or the like may be used. As the metal sulfide, for example, titanium sulfide such as TiS₂, for example, molybdenum sulfide such as MoS₂, for example, iron sulfides such as Fes, FeS₂, and LiₓFeS₂ (0≤x≤2) may be used. As the metal nitride, for example, lithium cobalt nitride (for example, LiₓCo_{y}N; 0<x<4, 0<y<0.5) may be used.

Other than the above lithium titanium composite oxides, lithium titanium composite oxides such as monoclinic niobium titanium oxides and orthorhombic titanium-containing composite oxides may be used for the negative electrode active material.

Examples of the monoclinic niobium titanium oxide include a compound represented by LiₐTi₁₋ₓM1ₓNb_{2-y}M2_{y}O_{7+δ}. Here, M1 is at least one selected from the group consisting of Zr, Si, and Sn. M2 is at least one selected from the group consisting of V, Ta, and Bi. The respective subscripts in the composition formula are specified as follows: 0≤a≤5, 0≤x<1, 0≤y<2, and −0.3≤δ≤0.3. Specific examples of the monoclinic niobium titanium oxide include LiₐNb₂TiO₇ (0≤a≤5).

Another example of the monoclinic niobium titanium oxide is a compound represented by LiₐTi₁₋ₓM3_{x+y}Nb_{2-y}O_{7-δ}. Here, M3 is at least one selected from the group consisting of Mg, Fe, Ni, Co, W, Ta, and Mo. The respective subscripts in the composition formula are specified as follows: 0≤a<5, 0≤x<1, 0≤y<2, and −0.3≤δ≤0.3.

Examples of the orthorhombic titanium-containing composite oxide include a compound represented by Li₂₊ₐM4₂₋ₓTi_{6-y}M5_{z}O_{14+σ}. Here, M4 is at least one selected from the group consisting of Sr, Ba, Ca, Mg, Na, Cs, Rb and K. M5 is at least one selected from the group consisting of Zr, Sn, V, Nb, Ta, Mo, W, Y, Fe, Co, Cr, Mn, Ni and Al. The respective subscripts in the composition formula are specified as follows: 0≤a≤6, 0≤x<2, 0≤y<6, 0≤z<6, and −0.5≥σ≤0.5. Specific examples of the orthorhombic titanium-containing composite oxide include Li₂₊ₐNa₂Ti₆O₁₄ (0≤a≤6).

One of the above active materials may be contained in the negative electrode as the negative electrode active material, or two or more thereof may be contained in the negative electrode as the negative electrode active materials.

### <Electro-Conductive Agent>

Examples of the electro-conductive agent include carbonaceous materials such as acetylene black, carbon black, graphite, carbon nanofibers, and carbon nanotubes. These carbonaceous materials may be used alone, or a plurality of the carbonaceous substances may be used.

### <Binder>

Examples of the binder include polytetrafluoroethylene (PTFE), polyvinylidene fluoride (PVdF), fluororubbers, and styrene-butadiene rubber (SBR). In addition, carboxymethyl cellulose (CMC), polyimide, polyamide, and the like may be used as the binder. These binders may be used alone, or a plurality of the binders may be used.

### <Negative Electrode Current Collector>

As the negative electrode current collector, a material that is electrochemically stable at a potential at which the lithium ion insertion-extraction reaction of the negative electrode active material occurs can be used. The negative electrode current collector is preferably a metal foil made of at least one selected from copper, nickel, stainless steel, and aluminum, or an aluminum alloy foil containing at least one selected from the group consisting of Mg, Ti, Zn, Mn, Fe, Cu, and Si.

As the shape of the negative electrode current collector, various shapes can be adopted according to the application of the battery using the negative electrode.

The negative electrode current collector may include a portion that does not support the negative electrode active material-containing layer on the surfaces thereof. This portion can serve as a negative electrode current-collecting tab. Alternatively, the negative electrode may include a current-collecting tab separate from the negative electrode current collector.

### <Production Method>

The negative electrode can be produced by, for example, the following method.

First, the negative electrode active material, the binder, and optionally the electro-conductive agent are suspended in an appropriate solvent to prepare a slurry for producing a negative electrode. As the solvent, for example, a generally used solvent such as N-methylpyrrolidone is used. The obtained slurry is applied onto the negative electrode current collector. The applied slurry is dried and pressed, whereby a negative electrode including a negative electrode current collector and negative electrode active material-containing layer(s) formed on the negative electrode current collector can be obtained. Otherwise, the negative electrode active material, the binder, and optionally the electro-conductive agent may be formed into pellets, and the pellets may be used as the negative electrode active material-containing layer.

### (3) Separator

As the separator, a material having an electrically insulating property is used. The separator is not particularly limited as long as it has an insulating property, and may be, for example, a porous film or nonwoven fabric made of a polymer such as polyolefin, cellulose, polyethylene terephthalate, or vinylon. The materials for the separator may be used alone, or two or more thereof may be used in combination.

### (4) Electrolyte

Examples of the electrolyte include a liquid nonaqueous electrolyte prepared by dissolving an electrolyte salt (solute) in a nonaqueous solvent, a gel nonaqueous electrolyte which is a composite between the liquid nonaqueous electrolyte and a polymeric material, and the like.

Examples of the electrolyte salt include lithium salts such as lithium perchlorate (LiClO₄), lithium hexafluorophosphate (LiPF₆), lithium tetrafluoroborate (LiBF₄), lithium hexafluoroarsenate (LiAsF₆), lithium hexalithium antimonate (LiSbF₆), lithium difluoro phosphate (LiPO₂F₂), lithium trifluoromethanesulfonate (LiCF₃SO₃; a.k.a., LiTFS), lithium bistrifluoromethane sulfonylamide (Li(CF₃SO₂)₂N; a.k.a., LiTFSI), lithium bispentafluoroethane sulfonylamide {Li(C₂F₅SO₂)₂N; a.k.a., LiBETI}, lithium bisoxalatoborate {LiB(C₂O₄)₂; a.k.a., LiBOB}, and lithium difluoro (trifluoro-2-oxido-2-trifluoro-methylpropionate (2−)−0,0) phosphate {LiBF₂OCOOC(CF₃)₂, a.k.a.; LiBF₂(HHIB)}. These electrolyte salts may be used singularly, or alternatively, two or more may be mixed and used. Among them, LiPF₆ and LiBF₄ are particularly preferable.

The electrolyte salt is preferably dissolved within a range of 1 mol/L or more to 3 mol/L or more with respect to the nonaqueous solvent. With an electrolyte salt concentration within this range, performance in a case of flowing a current of high load can be further improved, while suppressing effects of viscosity increase due to raising the electrolyte salt concentration.

The nonaqueous solvent may be an organic solvent, for example, cyclic carbonates such as ethylene carbonate (EC), propylene carbonate (PC), and vinylene carbonate (VC); linear carbonates such as dimethyl carbonate (DMC), ethyl methyl carbonate (EMC), diethyl carbonate (DEC), and dipropyl carbonate (DPC); cyclic ethers such as tetrahydrofuran (THF) and 2-methyl tetrahydrofuran (2-MeTHE); linear ethers such as 1,2-dimethoxy ethane (1,2-DME); cyclic esters such as γ-butyrolactone (BL); cyclic esters such as methyl acetate, ethyl acetate, methyl propionate, and ethyl propionate; 1,3-dioxolane; acetonitrile (AN); and sulfolane (SL). These organic solvents may be used singularly or in a form of a mixture of two or more thereof. An organic solvent including a cyclic carbonate and/or a linear carbonate is preferably used.

Examples of the polymeric material used for the gel nonaqueous electrolyte include polyvinylidene fluoride (PVdF), polyacrylonitrile (PAN), polyethylene oxide (PEO), and the like.

### (5) Container Member

The container member may be formed from a laminate film or configured of a container made of a metal. A container made of resin such as polyolefin resin, polyvinyl chloride resin, polystyrene-based resin, acrylic resin, phenol resin, polyphenylene-based resin, and fluorine-based resin may also be used for the container member. When a metal container is used, the lid and container may be a single entity or separate components. A wall thickness of the metal container is desirably 3 mm or less, and more preferably 0.5 mm or less.

Examples of the shape of the container member include a flat shape (thin shape), a prismatic shape, a cylindrical shape, a coin shape, a button shape, a sheet shape, a stacked shape, and the like. The container member may be one for a small-sized battery installed in a portable electronic device and the like, and may also be a container member for a large-sized battery installed on a two-wheeled to four-wheeled automobile.

A wall thickness of the container member made of laminate film is desirably 0.5 mm or less. Examples of the laminate film include a multilayer film including resin layers and a metal layer disposed between the resin layers. The metal layer is preferably made of an aluminum foil or an aluminum alloy foil for the sake of weight reduction. For the resin layers, for example, a film made of a polymer material such as polypropylene (PP), polyethylene (PE), nylon, or polyethylene terephthalate (PET) may be used. The laminate film may be molded into the shape of the container member by thermal sealing.

The metal container is made of aluminum, an aluminum alloy, or the like. The aluminum alloy preferably contains an element such as magnesium, zinc, or silicon. When the alloy contains a transition metal such as iron, copper, nickel, and chromium, the content thereof is preferably 100 ppm or less.

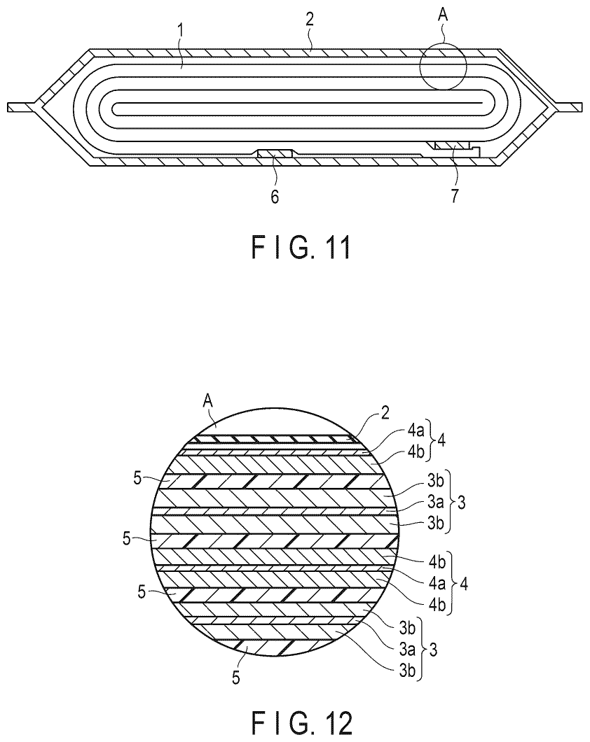

An example of the battery will be described with reference to FIG. 11 and FIG. 12. A flat battery shown in FIG. 11 is provided with a flat shaped wound electrode group 1, a container member 2, a positive electrode terminal 7, a negative electrode terminal 6, and an electrolyte (not shown). The container member 2 is a bag-form container member made of laminate film. The wound electrode group 1 is housed in the container member 2. As shown in FIG. 12, the wound electrode group 1 includes a positive electrode 3, a negative electrode 4 and a separator 5, and is formed by having a stack, with stacking in the order of the negative electrode 4, separator 5, positive electrode 3 and separator 5 from the outside, be spirally wound and subjected to press molding.

The positive electrode 3 includes a positive electrode current collector 3a and positive electrode active material-containing layers 3b. The positive electrode active material-containing layers 3b contain a positive electrode active material. A positive electrode active material-containing layer 3b is formed on both faces of the positive electrode current collector 3a. The negative electrode 4 includes a negative electrode current collector 4a and negative electrode active material-containing layers 4b. The negative electrode active material containing layers 4b contain a negative electrode active material. Among the negative electrode 4, at the portion positioned outermost, a negative electrode active material containing layer 4b is formed only on one face on the inner surface side of the negative electrode current collector 4a. At the other portions of the negative electrode 4, a negative electrode active material containing layer 4b is formed on both faces of the negative electrode current collector 4a.

As shown in FIG. 11, the positive electrode terminal 7 is connected to the positive electrode 3 in vicinity of the outer peripheral end of the wound electrode group 1. The negative electrode terminal 6 is connected to the negative electrode 4 at the outermost portion. The positive electrode terminal 7 and the negative electrode terminal 6 are extended to the outside through an opening of the container member 2.

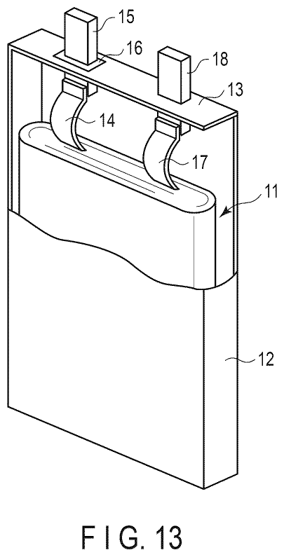

The battery is not limited to one having the configuration shown in FIG. 11 and FIG. 12 described above, but may be of a configuration shown in FIG. 13, for example.

In a prismatic battery shown in FIG. 13, a wound electrode group 11 is housed in a bottomed rectangular tubular container 12 made of metal as the container member. A rectangular lid 13 is welded to the opening of the container 12. The flat wound electrode group 11 may have, for example, a configuration similar to the wound electrode group 1 described with reference to FIG. 11 and FIG. 12.

One end of a negative electrode current collecting tab 14 is electrically connected to the negative electrode current collector and the other end thereof is electrically connected to a negative electrode terminal 15. The negative electrode terminal 15 is fixed to the rectangular lid 13 by a hermetic seal with a glass material 16 interposed. One end of a positive electrode current collecting tab 17 is electrically connected to the positive electrode current collector and the other end is electrically connected to a positive electrode terminal 18 fixed to the rectangular lid 13.

The negative electrode current collecting tab 14 is made of a material such as aluminum or an aluminum alloy containing elements such as Mg, Ti, Zn, Mn, Fe, Cu, Si, and the like. The negative electrode current collecting tab 14 is preferably formed of the same material as that of the negative electrode current collector, so as to reduce the contact resistance with the negative electrode current collector.

The positive electrode current collecting tab 17 is made of a material such as aluminum or an aluminum alloy containing elements such as Mg, Ti, Zn, Mn, Fe, Cu, Si, and the like. The positive electrode current collecting tab 17 is preferably formed of the same material as that of the positive electrode current collector, so as to reduce the contact resistance with the positive electrode current collector.

In the illustrated battery, the wound electrode group in which the separator is wound together with the positive electrode and the negative electrode has been used, but there may be used a stacked electrode group in which positive electrodes and negative electrodes are alternately stacked with the separator(s) interposed therebetween.

The battery according to the second embodiment includes the battery according to the first embodiment. Therefore, the battery is excellent in capacity retention ratio and the resistance increase thereof is suppressed, and thus, the battery exhibits excellent life performance.

### Third Embodiment

According to a third embodiment, a battery pack is provided. The battery pack includes the battery according to the second embodiment.

The battery pack according to the third embodiment may include one or plural of the battery (single-battery) according to the second embodiment described above. The plural batteries that may be included in the battery pack may be electrically connected in series or in parallel to configure a battery module. The battery pack may include plural battery modules.

Next, an example of a battery pack according to the third embodiment will be described with reference to the drawings.

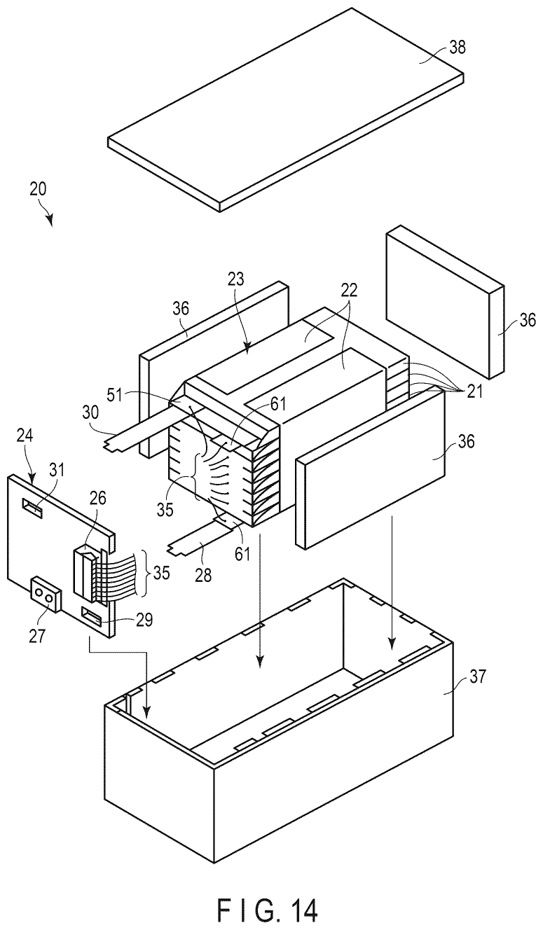

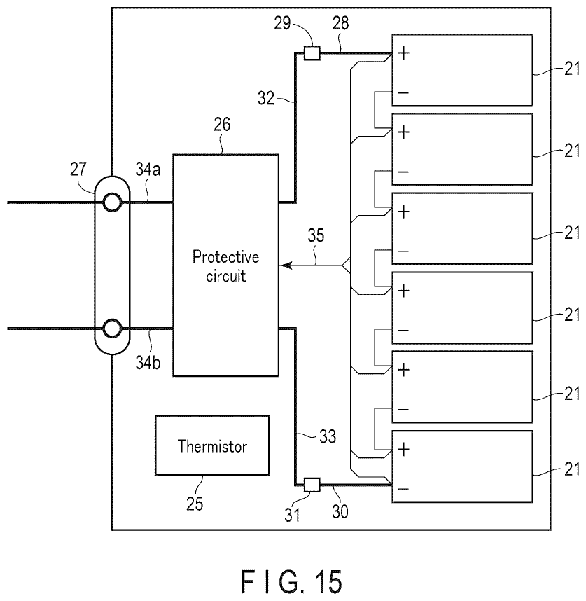

FIG. 14 is an exploded perspective view of an example of the battery pack according to the second embodiment. FIG. 15 is a block diagram showing an electric circuit of the battery pack shown in FIG. 14.

The battery pack 20 shown in FIG. 14 and FIG. 15 includes plural single-batteries 21. The single-battery 21 may be the exemplar flat battery according to the second embodiment described with reference to FIG. 13.

The plural single-batteries 21 are stacked so that negative electrode terminals 51 and positive electrode terminals 61 extending outside are aligned in the same direction and are fastened with an adhesive tape 22 to configure a battery module 23. These single-batteries 21 are electrically connected in series with each other as shown in FIG. 15.

A printed wiring board 24 is disposed facing the side surface from which the negative electrode terminals 51 and the positive electrode terminals 61 of the single-batteries 21 extend. As shown in FIG. 15, the printed wiring board 24 is installed with a thermistor 25, a protective circuit 26, and an energizing terminal 27 to external equipment. Note that an insulating plate (not shown) is attached to the surface of the printed wiring board 24 which faces the battery module 23 so as to avoid unnecessary connection with the wiring of the battery module 23.

A positive electrode side lead 28 is connected to the positive electrode terminal 61 located lowermost in the battery module 23, and its tip is inserted into a positive electrode side connector 29 of the printed wiring board 24 and electrically connected thereto. A negative electrode side lead 30 is connected to the negative electrode terminal 51 located uppermost in the battery module 23, and its tip is inserted into the negative electrode side connector 31 of the printed wiring board 24 and electrically connected thereto. These connectors 29 and 31 are connected to the protective circuit 26 through wiring 32 and the wiring 33 formed on the printed wiring board 24.

The thermistor 25 detects the temperature of the single-batteries 21, and the detection signal is transmitted to the protective circuit 26. The protective circuit 26 can shut off a plus-side wiring 34a and a minus-side wiring 34b between the protective circuit 26 and the energizing terminal 27 to external equipment in accordance to a predetermined condition. An example of the predetermined condition is, for example, when the temperature detected by the thermistor 25 becomes a predetermined temperature or higher. Another example of the predetermined condition is, for example, when overcharge, over-discharge, overcurrent, or the like of the single-battery 21 is detected. Detection of the overcharge or the like is performed for each of the individual single-batteries 21 or the entire battery module 23. In the case of detecting each single-battery 21, a battery voltage may be detected, or a positive electrode potential or a negative electrode potential may be detected. In the latter case, a lithium electrode used as a reference electrode is inserted into each single-battery 21. In the case of the battery pack 20 of FIG. 14 and FIG. 15, wiring 35 for voltage detection is connected to each of the single-batteries 21. Detection signals are transmitted to the protective circuit 26 through the wiring 35.

Protective sheets 36 made of rubber or resin are respectively arranged on three side surfaces of the battery module 23 excluding the side surface from which the positive electrode terminal 61 and the negative electrode terminal 51 protrude.

The battery module 23 is housed in a housing container 37 together with each protective sheet 36 and the printed wiring board 24. That is, the protective sheets 36 are disposed in the housing container 37 respectively on both inner side surfaces in a long-side direction and the inner side surface in a short-side direction, and the printed wiring board 24 is disposed on the inner side surface at the opposite side in the short-side direction. The battery module 23 is located in a space surrounded by the protective sheets 36 and the printed wiring board 24. A lid 38 is attached to the upper surface of the housing container 37.

For fixing the battery module 23, a thermal shrinkage tape may be used in place of an adhesive tape 22. In this case, after the protective sheets are disposed on each side surface of the battery module and a thermal shrinkage tape is wound, the thermal shrinkage tape is thermally shrunk, to bind the battery module.

In FIG. 14 and FIG. 15, the single-batteries 21 are connected in series, but the single-batteries 21 may be connected in parallel in order to increase the battery capacity. Further, assembled battery packs may also be connected in series and/or parallel.

The mode of the battery pack is appropriately changed depending on the application. A preferable application of the battery pack is one where good cycle performance is desired when a large current is extracted. Specific examples of the applications include that for a power source of a digital camera, and for use in a vehicle such as a two-wheeled to four-wheeled hybrid electric automobile, a two-wheeled to four-wheeled electric automobile, and a power-assisted bicycle. The battery pack is particularly favorably used for onboard use.

The battery pack according to the third embodiment includes the battery according to the second embodiment. Therefore, the battery pack is excellent in capacity retention ratio and the resistance increase thereof is suppressed, and thus, the battery pack exhibits excellent life performance.

### EXAMPLES

The present invention will be described in more detail with reference to examples described below, but the invention is not limited to the examples listed below, as long as the spirit of the invention is not exceeded.

### Example 1

### <Production of Positive Electrode>

A lithium-nickel-cobalt-manganese composite oxide LiNi_{0.8}Co_{0.1}Mn_{0.1}O₂ having an average primary particle size of 3.7 μm as a positive electrode active material, acetylene black as a first electro-conductive agent, graphite as a second electro-conductive agent, and polyvinylidene fluoride (PVdF) as a binder were prepared. Among the prepared materials, the first and second electro-conductive agents were each stirred with a planetary mixer in a powder state, and then they were mixed together and stirred again. The other materials were put into N-methylpyrrolidone (NMP), and then the electro-conductive agents after stirring were added. The prepared materials in the NMP solution were mixed to obtain a slurry for positive electrode production in which the materials were suspended in the NMP. Further, the slurry for positive electrode production was dispersed. Zirconia beads of 2 mm φ were put into the slurry and stirred with a planetary mixer to uniformly disperse the materials.

The mass ratios of the positive electrode active material, the first electro-conductive agent, the second electro-conductive agent, and the binder put into the NMP were 100 parts by mass, 5 parts by mass, 5 parts by mass, and 5 parts by mass, respectively.

The obtained slurry was applied onto both surfaces of an aluminum foil (current collector) with a band shape and a thickness of 12 μm, and dried. Through a pressing step, a positive electrode having a current collector and an active material-containing layer on both sides thereof was produced.

### <Production of Negative Electrode>

Spinel lithium titanate Li₄Ti₅O₁₂ as the negative electrode active material, graphite as the electro-conductive agent, and PVdF as the binder were prepared. The prepared materials were suspended in N-methylpyrrolidone to obtain a slurry for producing a negative electrode. The mass ratios of the negative electrode active material, electro-conductive agent, and binder put into N-methylpyrrolidone were 95% by mass, 2.5% by mass, and 2.5% by mass, respectively. The prepared slurry for producing the negative electrode was applied onto both surfaces of an aluminum foil (current collector) having a band shape and a thickness of 12 μm, then dried. Thereafter, by performing a pressing process, a negative electrode was produced.

### <Production of Electrode Group>

The positive electrode and the negative electrode produced as described above were stacked with a separator interposed therebetween. As the separator, a separator made of cellulose and having a thickness of 14 μm and a width of 85 mm was used. The obtained stack was wound, taking an axis extending in the short side direction of the positive electrode current collector and the negative electrode current collector as the center. The positive electrode, negative electrode, and separator wound as described above were subjected to a heat press at 80° C. and fixed with an insulating tape. Thus, a wound electrode group including the positive electrode, the negative electrode, and the separator positioned between the positive electrode and the negative electrode was obtained.

### <Preparation of Nonaqueous Electrolyte>

Propylene carbonate (PC) and diethyl carbonate (DEC) were mixed at a volume ratio of 1:1, to thereby prepare a nonaqueous solvent. Lithium hexafluorophosphate LiPF₆ was dissolved in the obtained nonaqueous solvent at a concentration of 1.0 mol/L, to thereby prepare a nonaqueous electrolyte.

### <Assembly of Battery>

The electrode group formed into a flat shape that had been obtained as explained above was inserted into a metal can formed of an aluminum plate having a plate thickness of 0.5 mm. The opening of the metal can was sealed with a sealing plate, to thereby house the electrode group in the metal can as the container member. The nonaqueous electrolyte prepared as described above was poured into the container through an electrolytic solution inlet provided on the sealing plate. Next, a sealing lid was welded to the periphery of the electrolytic solution inlet, to thereby prepare a flat nonaqueous electrolyte battery.

### Examples 2 and 3, Comparative Examples 1 to 6

In Examples 2 and 3 and Comparative Examples 1 to 6, batteries were produced in the same manner as in Example 1 except that the average particle sizes of the positive electrode active material, the first electro-conductive agent, and the second electro-conductive agent were changed from that in Example 1 as indicated in Table 2, and the design of the positive electrode active material-containing layer was changed to those indicated in Tables 2 and 3 by adjusting the parts by mass of each electro-conductive agent, the dispersion condition of the slurry for positive electrode production, and the pressing load of the active material-containing layer. As for the design of the positive electrode active material-containing layer, the specific surface area by the nitrogen adsorption/desorption method (BET method) and the electrode density, and the occupancy areas S1 and S2 of the first and second electro-conductive agents, the occupancy area Sa of the positive electrode active material, the inter-centroid distances R1 and R2 of the first and second electro-conductive agents, the inter-centroid distances R1-2 between the electro-conductive agents, and the inter-centroid distance Ra of the positive electrode active material in the constituent material mapping image obtained by the above-described Raman spectroscopy were adjusted as indicated in Tables 2 and 3.

The following Table 2 summarizes the design of the positive electrode active material-containing layer in each Example and each Comparative Example. Indicated as the design of the active material-containing layer are the average primary particle size of the positive electrode active material particles, the specific surface area measured by the nitrogen adsorption/desorption method (BET method) described above, the average particle size of the first electro-conductive agent and the mass ratio thereof to the positive electrode active material, the average particle size of the second electro-conductive agent and the mass ratio thereof to the positive electrode active material, and the density measured by the method described above.

The following Table 3 summarizes analysis results of a constituent material mapping image obtained by Raman spectroscopy on the positive electrode active material-containing layer in each Example and each Comparative Example. Indicated as results of the image analysis are the occupancy areas S1 and S2 of the first and second electro-conductive agents, the occupancy area Sa of the positive electrode active material, the ratios of the occupancy area S1/Sa and S2/Sa, the inter-centroid distances R1 and R2 of the first and second electro-conductive agents, the inter-centroid distance R1-2 between the electro-conductive agents, the inter-centroid distance Ra of the positive electrode active material, and the ratios R1/Ra and R2/Ra of the inter-centroid distances.

TABLE 2

| | | | First | | Second | | |
|---|---|---|---|---|---|---|---|
| | Positive | | electro-conductive | | electro-conductive | | Positive |
| | electrode | | agent | | agent | | electrode |
| | active material | | Mass ratio | | Mass ratio | | active |
| | Average | | relative to | | relative to | | material- |
| | primary | Specific | positive | Average | positive | Average | containing |
| | particle | surface | electrode | particle | electrode | particle | layer |
| | size | area | active | size | active | size | Density |
| | [μm] | [m²/g] | material | [nm] | material | [μm] | [g/cm³] |
| Example 1 | 3.7 | 0.7 | 0.07 | 35 | 0.1 | 1 | 3.3 |
| Example 2 | 3.6 | 0.81 | 0.06 | 35 | 0.08 | 1 | 3.25 |
| Example 3 | 4.1 | 0.58 | 0.06 | 35 | 0.08 | 1 | 3.2 |
| Comparative | 3.7 | 0.7 | 0.07 | 35 | 0.03 | 1 | 3.3 |
| Example 1 | | | | | | | |
| Comparative | 3.7 | 0.7 | 0.1 | 35 | 0.03 | 1 | 3.3 |
| Example 2 | | | | | | | |
| Comparative | 3.7 | 0.7 | 0.04 | 35 | 0.02 | 1 | 3.3 |
| Example 3 | | | | | | | |
| Comparative | 5.4 | 0.5 | 0.01 | 50 | 0.10 | 2 | 3.5 |
| Example 4 | | | | | | | |
| Comparative | 4.5 | 0.9 | 0.01 | 30 | 0.09 | 2 | 3.0 |
| Example 5 | | | | | | | |
| Comparative | 4.5 | 0.9 | 0.01 | 30 | 0.09 | 2 | 2.6 |
| Example 6 | | | | | | | |

| | Positive electrode active material-containing layer | | | | | | | | | | |
|---|---|---|---|---|---|---|---|---|---|---|---|
| | S1 | S2 | Sa | | | R1 | R2 | R1-2 | Ra | | |
| | [μm²] | [μm²] | [μm²] | S1/Sa | S2/Sa | [μm] | [μm] | [μm] | [μm] | R1/Ra | R2/Ra |
| Example 1 | 17.2 | 571.7 | 159.6 | 0.11 | 3.58 | 11.8 | 5.9 | 5.4 | 8.9 | 1.33 | 0.66 |
| Example 2 | 15.5 | 457.4 | 128.1 | 0.12 | 3.57 | 13 | 7.4 | 5.5 | 8.8 | 1.48 | 0.84 |
| Example 3 | 14.7 | 435 | 167.8 | 0.11 | 2.59 | 13.8 | 7.8 | 5.3 | 9.3 | 1.49 | 0.84 |
| Comparative | 128.6 | 186.9 | 140 | 0.92 | 1.34 | 7.6 | 11.8 | 5.9 | 10.3 | 0.74 | 1.15 |
| Example 1 | | | | | | | | | | | |
| Comparative | 68 | 136.3 | 73.3 | 0.93 | 1.86 | 9.7 | 10.5 | 6.7 | 14.2 | 0.68 | 0.74 |
| Example 2 | | | | | | | | | | | |
| Comparative | 189.8 | 91.1 | 107 | 1.77 | 0.85 | 6.6 | 13 | 5.5 | 12 | 0.55 | 1.08 |
| Example 3 | | | | | | | | | | | |
| Comparative | 11.5 | 574.5 | 143.6 | 0.08 | 4 | 10.4 | 9.9 | 7.8 | 6.5 | 1.60 | 1.52 |
| Example 4 | | | | | | | | | | | |
| Comparative | 12 | 442.4 | 39.9 | 0.3 | 11.1 | 13.6 | 9.5 | 18.8 | 6.1 | 2.23 | 1.56 |
| Example 5 | | | | | | | | | | | |
| Comparative | 10.1 | 661.3 | 89.1 | 0.11 | 7.42 | 10.2 | 5.1 | 12.8 | 6.0 | 1.70 | 0.85 |
| Example 6 | | | | | | | | | | | |

<Measurement of Volume Resistivity of Active Material-containing Layer>

The volume resistivity (unit: Ω·cm) of the active material-containing layer of the positive electrode was measured as follows. The electrode was taken out from the battery by the method described in the section <Electrode Measurement Method>, and the taken out electrode was sampled.

Sampling was performed by selecting a portion where the surface of the active material-containing layer was as smooth as possible and cutting out a sample with a size of 10 cm×10 cm. The cut out electrode sample was placed on an electrode resistance measurement device without bending, and the electrode probe was pressed against the electrode sample to measure the volume resistance of the active material-containing layer. As the electrode resistance measurement device, an electrode resistance measurement system RM2610 manufactured by HIOKI E.E. Corporation was used. The measurement was performed in the potential measurement+calculation mode, the resistance range was set to the Auto range, and the number of iterations of calculation was set to 30. In the above mode, the iterative calculations are performed while changing the resistance value used for a virtual model until, the difference with respect to the potential obtained by performing simulation using the virtual model of the potential distribution obtained when the constant current flows on the surface of the measurement target electrode, that is, the difference between the simulated potential and the measured potential becomes small. The volume resistivity was determined from the resistance value when the difference between the model and the actual measurement became sufficiently small.

### <Cycling Test>

For each of the produced batteries, a cycling test was performed as follows.

First, the battery was charged in a 25° C. environment, and adjusted to a state of charge (SOC) of 50%. Subsequently, after waiting for 1 hour, the OCV (open circuit voltage) at that time was recorded. Thereafter, the battery was discharged at a current value of 10 C, and a voltage drop at that time was measured. The value of the OCV was subtracted from the value of the voltage drop at 10 C discharge, and the obtained value was divided by the current value of 10 C, thereby obtaining a discharge resistance value (unit: mΩ) of the battery.

Then, 700 cycles where, in a 65° C. environment, the battery was charged at 3 C rate up to a state of charge (SOC) of 100% and discharged at 3 C rate down to a SOC of 0% were performed. The discharge capacities were measured at the time of discharge at the first cycle and the 700th cycle.

After carrying out the discharge at the 700th cycle, the discharge resistance value of the battery was measured again.

From the discharge capacities for the first cycle and the 700th cycle, the capacity retention ratio was calculated using the following equation: capacity retention ratio (unit: %)=[discharge capacity at 700th cycle/discharge capacity at first cycle]×100%. From the discharge resistance values before and after carrying out 700 cycles of charge and discharge, the resistance increase ratio was calculated using the following formula: resistance increase ratio (unit: %)=[discharge resistance value after carrying out cycles/discharge resistance value before carrying out cycles]×100%. The calculated results are shown in Table 4 below.

TABLE 4

| | |
|---|---|
| Positive electrode | Battery |

| | Active material- | Capacity | |
|---|---|---|---|
| | containing layer | retention | Resistance |
| | volume resistivity | ratio | increase |
| | [Ω · cm] | [%] | [%] |
| Example 1 | 1.33 | 96 | 26 |
| Example 2 | 1.55 | 95 | 29 |
| Example 3 | 1.21 | 97 | 13 |
| Comparative | 4.66 | 88 | 49 |
| Example 1 | | | |
| Comparative | 1.63 | 82 | 33 |
| Example 2 | | | |
| Comparative | 16.41 | 78 | 190 |
| Example 3 | | | |
| Comparative | 14.82 | 71 | 301 |
| Example 4 | | | |
| Comparative | 14.44 | 72 | 242 |
| Example 5 | | | |
| Comparative | 37.54 | 69 | 318 |
| Example 6 | | | |

Table 4 indicates that the batteries produced in Examples 1 to 3 exhibited a low electrode resistivity and achieved an excellent capacity retention ratio. On the other hand, in Comparative Examples 1 to 6, it is found that all of the volume resistivity of the positive electrodes, the capacity retention ratios of the batteries, and the suppression of the increase in resistance were inferior to those in Examples 1 to 3. This is because in each of Examples 1 to 3, a positive electrode active material-containing layer was obtained in which the ratios of the occupancy areas S1 and S2 of the first and second electro-conductive agents to the occupancy area Sa of the active material satisfy 0.1<S1/Sa<1.0 and 0.8<S2/Sa<10 in the constituent material mapping image obtained using Raman spectroscopy, and the ratio of the inter-centroid distances R1 and R2 of the first and second electro-conductive agents to the inter-centroid distance Ra of the active material satisfies 1.0<R1/Ra<1.5 and 0.5<R2/Ra<1.0, and further, the inter-centroid distances R1 and R2 of the first and second electro-conductive agents satisfy the relationship R1>R2>R1-2 with the inter-centroid distance R1-2 between the first electro-conductive agent and the second electro-conductive agent in the constituent material mapping image, and thus, the proportions and positional relationships between each electro-conductive agent and the active material were appropriately controlled such that the electrical conductive network between the particles in the positive electrode active material-containing layer and the entire positive electrode active material-containing layer was favorable.

On the other hand, in each of the batteries of Comparative Examples 1 to 6, the positive electrode active material-containing layer did not satisfy at least one of the above conditions, and all of the volume resistivity of the positive electrode active material-containing layer, the capacity retention ratio, and the suppression of increase in resistance of the battery were inferior to those of Examples 1 to 3. Namely, since the electrode resistivity was not suppressed to a low level because an electrical conductive path was not formed for the entire positive electrode active material-containing layer, local deterioration of the active material was not suppressed, and as a result, both the capacity retention ratio and the resistance increase suppression were not excellent.

Specifically, in Comparative Example 1, the occupancy area of each electro-conductive agent was within the above-described range, but regarding the distance between centroids, R1/Ra was small and R2/Ra was large, both falling outside the above-described ranges. In addition, R2 was longer than R1. In Comparative Example 1, the volume resistivity of the positive electrode was high, and the capacity retention ratio of the battery was lower and the resistance increase ratio was higher than those in Examples 1 to 3. The proportion of the electro-conductive agent in the active material-containing layer was appropriate, but the positional relationship was not appropriate, and the formation of an electrical conductive network in the positive electrode and the retention of electrical conductivity between particles were not achieved. As a result, it can be seen that the electric resistance was increased even in the positive electrode alone, and the increase in resistance had advanced with the charge-discharge cycle due to the uneven distribution of the reaction. Specifically, it can be seen from the small R1/Ra that the first electro-conductive agent with high electrical conductivity was excessively present around the active material, the volume resistance of the electrode was reduced to make current unevenness likely to occur, and local deterioration of the active material had advanced. In addition, it can be seen from the large R2/Ra that the second electro-conductive agent was low in amount near the active material and the first electro-conductive agent, an electrical conductive path was not formed for the entire active material-containing layer, and local deterioration of the active material was not suppressed.

In Comparative Example 2, as well, the occupancy area was within the range, but regarding the distance between centroids, R1/Ra was small and R2 was longer than R1. In Comparative Example 2, the volume resistivity of the positive electrode and the resistance increase of the battery were relatively low, but the capacity retention ratio of the battery was further lower than that in Comparative Example 1. Namely, although the proportion of the electro-conductive agent in the active material-containing layer was appropriate, the positional relationship of the first electro-conductive agent was not appropriate. From the R2/Ra within the above range, it can be seen that an electrical conductive path was favorably formed by the second electro-conductive agent. However, it can be seen from the small R1/Ra that the first electro-conductive agent with high electrical conductivity was excessively present around the active material. As a result, the degree of use of the active material locally increased near the first electro-conductive agent, so that the local deterioration of the positive electrode associated with the charge-discharge cycle and the decrease in the capacity retention ratio due to the uneven utilization had advanced.

In Comparative Example 3, S1/Sa was large, making the occupancy area out of the range. Regarding the distance between centroids, R1/Ra was small, R2/Ra was large, and R2 was longer than R1, as in Comparative Example 1. In Comparative Example 3, the volume resistivity of the positive electrode was even higher than that in Comparative Example 1, and the capacity retention ratio of the battery was even lower and the resistance increase was even higher as compared to Comparative Example 1. In Comparative Example 3, since the amount of the first electro-conductive agent was excessively large as indicated by the large S1/Sa, the formation of aggregates had advanced, and the aggregates were present near the active material as indicated by the small R1/Ra. In addition, as indicated by the large R2/Ra, an electrical conductive path was not formed by the second electro-conductive agent. As a result, it can be seen that the electrical conductivity was not improved for the whole of the active material-containing layer, and rather, the current unevenness due to the excessive concentration of the first electro-conductive agent near the active material became remarkable, and the local deterioration of the active material had advanced.

In Comparative Example 4, S1/Sa was small, making the occupancy area out of the range. Regarding the distance between centroids, both R1/Ra and R2/Ra were large, and were out of the range. In Comparative Example 4, the volume resistivity of the positive electrode was high, the capacity retention ratio of the battery was low, and the resistance increase ratio was significantly high. It can be seen from the small S1/Sa that the proportion of the first electro-conductive agent with high electrical conductivity was small, and it can be seen from the large R1/Ra and R2/Ra that each electro-conductive agent was low in amount near the active material. Therefore, it can be seen that not only was an electrical conductive path for the entire active material-containing layer not formed, but also the electrical conductivity was not even locally enhanced, and as a result, on top of having the current unevenness, the electrical resistance was not that small even at a portion where a relatively large amount of current flowed, so that the local deterioration of the active material had advanced.

In Comparative Example 5, S2/Sa was large, making the occupancy area out of the range. Regarding the distance between centroids, both R1/Ra and R2/Ra were large, and R1-2 was longer than R2. In Comparative Example 5, the volume resistivity of the positive electrode was high, the capacity retention ratio of the battery was low, and the resistance increase ratio was considerably high. It can be seen from the large S2/Sa that the proportion of the second electro-conductive agent was excessively high, and it can be seen from the large R1/Ra and R2/Ra that each electro-conductive agent was low in amount near the active material. Therefore, it can be seen that the local deterioration of the active material was advanced in the active material-containing layer.

In Comparative Example 6, the occupancy area was within the range, but R1/Ra was large and out of the range. In Comparative Example 6, the volume resistivity of the positive electrode was significantly high, the capacity retention ratio of the battery was low, and the resistance increase ratio was higher than that in Comparative Example 4. It can be seen from the large R1/Ra that the first electro-conductive agent was low in amount near the active material and the first electro-conductive agent. Therefore, it can be seen that the current required for the charge-discharge reaction was not transmitted to the active material, and the electric resistance increased, whereby the deterioration of the active material had advanced.

According to at least one embodiment and example described above, an electrode is provided. The electrode includes an active material-containing layer that contains an active material, a first electro-conductive agent whose ratio I_{D}/I_{G} of an integral intensity I_{D} of a D band to an integral intensity I_{G} of a G band in a Raman chart is 0.5<I_{D}/I_{G}<2, and a second electro-conductive agent whose ratio I_{D}/I_{G} is 0<I_{D}/I_{G}<0.5. In a constituent material mapping image according to Raman spectroscopy of the active material-containing layer, an occupancy area S1 of the first electro-conductive agent, an occupancy area S2 of the second electro-conductive agent, and an occupancy area Sa of the active material, satisfy relationships of 0.1<S1/Sa<1.0 and 0.8<S2/Sa<10. In the constituent material mapping image, an inter-centroid distance R1 of the first electro-conductive agent, an inter-centroid distance R2 of the second electro-conductive agent, an inter-centroid distance Ra of the active material, and an inter-centroid distance R1-2 between the first electro-conductive agent and the second electro-conductive agent satisfy relationships of 1.0<R1/Ra<1.5, 0.5<R2/Ra<1.0, and R1>R2>R1-2. The above electrode can realize a battery and battery pack with little electrical resistance that is excellent in life performance.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

Hereinafter, several embodiments of the invention will be described.
1. An electrode comprising an active material-containing layer containing an active material, a first electro-conductive agent, and a second electro-conductive agent,
a ratio I_{D}/I_{G} of an integral intensity I_{D} of a D band appearing at 1350±10 cm⁻¹ to an integral intensity I_{G} of a G band appearing at 1590±10 cm⁻¹ for the first electro-conductive agent in a Raman chart according to Raman spectroscopy on the active material-containing layer falling within a range of 0.5<I_{D}/I_{G}<2, and a ratio I_{D}/I_{G} for the second electro-conductive agent falling within a range of 0<I_{D}/I_{G}<0.5,
in a constituent material mapping image according to Raman spectroscopy on the active material-containing layer, a ratio S1/Sa of an occupancy area S1 of the first electro-conductive agent to an occupancy area Sa of the active material falling within a range of 0.1<S1/Sa<1.0, and a ratio S2/Sa of an occupancy area S2 of the second electro-conductive agent to the occupancy area Sa of the active material falling within a range of 0.8<S2/Sa<10, and
in the constituent material mapping image, a ratio R1/Ra of an inter-centroid distance R1 for the first electro-conductive agent to an inter-centroid distance Ra for the active material falling within a range of 1.0<R1/Ra<1.5, and a ratio R2/Ra of an inter-centroid distance R2 for the second electro-conductive agent to the inter-centroid distance Ra for the active material falling within a range of 0.5<R2/Ra<1.0, and the inter-centroid distance R1 for the first electro-conductive agent, the inter-centroid distance R2 for the second electro-conductive agent, and an inter-centroid distance R1-2 between the first electro-conductive agent and the second electro-conductive agent satisfying a relationship of R1>R2>R1-2.
2. The electrode according to clause 1,
wherein the active material comprises a compound represented by LiₐNi_{(1-b-c-d)}Co_{b}Mn_{c}M_{d}O₂, where 1≤a≤1.2, 0≤b≤0.4, 0≤c≤0.4, and 0≤d≤0.1, and M includes at least one selected from the group consisting of Fe, Cu, Ti, Mg, Al, W, Y, B, Mo, Nb, Zn, Sn, Zr, Ga, and V, and
the active material has an average primary particle size of 2 μm or more and 7 μm or less.
3. The electrode according to clause 1 or 2, wherein a specific surface area of the active material according to a nitrogen adsorption/desorption method is 0.5 m²/g or more and 1.0 m²/g or less.
4. The electrode according to any one of clauses 1 to 3, wherein an average particle size of the first electro-conductive agent is 100 nm or less, an average particle size of the second electro-conductive agent is 10 μm or less, and a mass ratio of each of the first electro-conductive agent and the second electro-conductive agent to the active material is 0.18 or less.
5. The electrode according to any one of clauses 1 to 4, wherein a density of the active material-containing layer is 2.0 g/cm³ or more and less than 4.0 g/cm³.
6. A battery comprising:
the electrode according to any one of clauses 1 to 5; and
an electrolyte.
7. A battery pack comprising the battery according to clause 6.

What is claimed is:

1. An electrode comprising an active material-containing layer containing an active material, a first electro-conductive agent, and a second electro-conductive agent,
a ratio I_{D}/I_{G} of an integral intensity I_{D} of a D band appearing at 1350±10 cm⁻¹ to an integral intensity I_{G} of a G band appearing at 1590±10 cm⁻¹ for the first electro-conductive agent in a Raman chart according to Raman spectroscopy on the active material-containing layer falling within a range of 0.5<I_{D}/I_{G}<2, and a ratio I_{D}/I_{G} for the second electro-conductive agent falling within a range of 0<I_{D}/I_{G}<0.5,
in a constituent material mapping image according to Raman spectroscopy on the active material-containing layer, a ratio S1/Sa of an occupancy area S1 of the first electro-conductive agent to an occupancy area Sa of the active material falling within a range of 0.1<S1/Sa<1.0, and a ratio S2/Sa of an occupancy area S2 of the second electro-conductive agent to the occupancy area Sa of the active material falling within a range of 0.8<S2/Sa<10, and
in the constituent material mapping image, a ratio R1/Ra of an inter-centroid distance R1 for the first electro-conductive agent to an inter-centroid distance Ra for the active material falling within a range of 1.0<R1/Ra<1.5, and a ratio R2/Ra of an inter-centroid distance R2 for the second electro-conductive agent to the inter-centroid distance Ra for the active material falling within a range of 0.5<R2/Ra<1.0, and the inter-centroid distance R1 for the first electro-conductive agent, the inter-centroid distance R2 for the second electro-conductive agent, and an inter-centroid distance R1-2 between the first electro-conductive agent and the second electro-conductive agent satisfying a relationship of R1>R2>R1-2.

2. The electrode according to claim 1,
wherein the active material comprises a compound represented by LiₐNi_{(1-b-c-d)}Co_{b}Mn_{c}M_{d}O₂, where 1≤a≤1.2, 0≤b≤0.4, 0≤c≤0.4, and 0≤d≤0.1, and M includes at least one selected from the group consisting of Fe, Cu, Ti, Mg, Al, W, Y, B, Mo, Nb, Zn, Sn, Zr, Ga, and V, and
the active material has an average primary particle size of 2 μm or more and 7 μm or less.

3. The electrode according to claim 1, wherein a specific surface area of the active material according to a nitrogen adsorption/desorption method is 0.5 m²/g or more and 1.0 m²/g or less.

4. The electrode according to claim 1, wherein an average particle size of the first electro-conductive agent is 100 nm or less, an average particle size of the second electro-conductive agent is 10 μm or less, and a mass ratio of each of the first electro-conductive agent and the second electro-conductive agent to the active material is 0.18 or less.

5. The electrode according to claim 1, wherein a density of the active material-containing layer is 2.0 g/cm³ or more and less than 4.0 g/cm³.

6. A battery comprising:
the electrode according to claim 1; and
an electrolyte.

7. A battery pack comprising the battery according to claim 6.
